(19) United States
(12) Patent Application Publication
(10) Pub. No.: US 2016/0195008 A1
(43) Pub. Date: Jul. 7, 2016

(54) Two-stroke opposed piston Rotary internal combustion engine with no reactive torque

(71) Applicant: Cesar Mercier, Roseland, NJ (US)

(72) Inventor: Cesar Mercier, Roseland, NJ (US)

(21) Appl. No.: 14/588,455

(22) Filed: Jan. 1, 2015

(51) Int. Cl. F02B 75/02; F02B 25/14; F02B 53/10

(52) U.S. Cl. CPC F02B 75/02; F02B 53/10; F02B 25/14; F02B 2075/025

(57) ABSTRACT

A two-cycle internal-combustion, rear compression, engine with variable valve timing, activated by air pressure and located at about top dead center. This engine has a variable compression ratio combustion chamber that is based on the speed that this engine is running at. This engine further operates with variable fuel and air ratio using air pressure. This engine runs lean whenever the throttle body is not fully open. This engine uses air pressure difference and throttle body position to constantly adjust fuel and air ratio for optimum efficiency. The synergy of this engine configuration allows for operator to be alerted when it is time to upshift and maintain maximum efficiency. This engine will prevent excessive speed and run at optimum efficiency by automatically running lean whenever engine speed is too high. This engine also runs on compression ignition, without electronics which is susceptible to electromagnetic pulse.

### RELATED APPLICATION

This patent application is related to U.S. Provisional Patent Application No. 61922810 filed by applicant on Jan. 1, 2014, and claims the benefit of that filing date

### BACKGROUND OF THE INVENTION

Engineers have been trying to improve on efficiency ever since the creation of the first internal combustion engine. Some of the best fuel efficient engines out there are only about 30% efficient. It is time to redesign the internal combustion engine in order to drastically improve its efficiency. A two-stroke engine, for all its advantages over a four-stroke, wastes fuel due to its forced induction through transfer ports where the fuel and air mixture is introduced to the combustion chamber at about Bottom Dead Center (BDC) where exhaust is flushed out, taken some of the incoming fuel mixture along. Patent number U.S. Pat. No. 4,450,794 and U.S. Pat. No. 4,791,892, titled “Two-stroke engine”, filed by Roger M. Hall, are good examples of this problem. Other two-stroke engines like the one described in patent NO. U.S. Pat. No. 5,189,996 where the exhaust valve is moved towards Top Dead Center (TDC) causes exhaust valve timing issues and exhaust pumping issues related to the exhaust momentum being reversed back to TDC to exit the combustion chamber. The compression ratio of the two stroke engines is just too little to be efficient. The present invention seeks to solve that with a Variable Compression Ratio (VCR) powered by engine speed and air pressure.

Another long standing goal in engine design is Variable Valve Timing (VVT), which would help to adjust air moving in and out of the combustion chamber. U.S. patent Ser. No. 5,083,533 titled “Two-stroke-cycle with variable valve timing” filed by Williams E. Richeson, is an example of the effort towards this goal. However, these solutions work with electronics and are complex. Others add more parts and more problems to the engine. Advances in VVT have helped a bit, but the solutions provided often involve complex hydraulic system, increasing in complexity. The present invention seeks to solve these problems with simple manipulation of air pressure.

Recent innovations related to electronic fuel injection systems have made good progress in using sensors and ECU maps to chart the right amount of fuel to be injected based on throttle body position and sensor readings throughout the engine. This ends up complicating the whole process to the point where it takes a well-trained mechanic with sophisticated tools to properly diagnose an engine. These complexities further cause the engine to be more prone to failure due to the additional components. We have yet to invent a Variable Fuel and Air Ratio (VFAR) system that is simple to implement without complicated electronics. This engine incorporates these features, solving the VFAR problem without the use of electronics.

Combustion chambers often produce a pinging sound, especially in Diesel engines, causing power loss and are destructive to the engine. Despite all the efforts and improvements, made to solve this issue, we still hear the pinging noise from those engines. If only we can invent a shape charged combustion chamber that will allow our engines to be more efficient. The present Shape Charged Combustion Chamber being outlined here seeks to solve this problem by using fluid flow principles.

Another long standing goal in engine design is to achieve lean burn while reducing NOx emissions. Many manufacturers try to achieve lean burn by using electronic components like injectors with a plurality of sensors. This solution has not been successful with two-strokes due to design limitations. The goal is to run an engine lean whenever we don't need extra power. This should be done without electronics or more parts. The present engine solves this problem with an Efficiency Management System (EMS), a synergy of components and configurations. Like a puzzle, when the right pieces are in place, it is easier to put the rest of the pieces together.

Another problem is with excessive speed. Most engines being massed produced are at the mercy of their owner when it comes to being over-powered, or misused. We need to come up with a solution to help protect the engine against users that may not know when to upshift. The present invention solves this problem of excessive engine speed by running lean to maintain maximum speed at optimum efficiency. This design now allows manufacturers to set their proper maximum speed for their engines, and without electronics. Coincidently, another problem related to the exact location and size of the exhaust port is solved, since this affect the compression ratio and torque.

Another problem with popular engines comes down to air management. The pistons have to push exhaust out, at times harder with turbocharger backflow. The cam shaft has to push valves open. The present engine solves these problems by design.

Another problem is with exhaust noise. Other solutions try to muffle the noise with exotic mufflers and more weight. The present invention approached the problem at the source, exhaust noise creation. It is like stopping the air vibration by disconnecting the speakers rather than soundproof your room.

Another problem is with reaction torque. Per Newton's law, “for every action there is an equal and opposite reaction”. The aircraft industry has a big problem with engine reaction torque when the propellers turn one way and the aircraft rolls the other way. Pilots are expected to counter this force through the control inputs to counter this effect. This is even more evident with helicopters tail rotors. The present invention solves this problem by using the opposite reaction forces to cancel each other.

Another problem is with piston skirts scraping cylinder walls due to side thrust reaction forces. Engineers have experimented with cam follower engines in the past. The design so far has not been better than that of conventional engines. The present design features a cam follower engine with a fraction of components found in conventional engines. The present invention incorporates side thrust management features allowing the pistons to move without brushing on the cylinder walls.

A one-cylinder two stroke engine is popular because of its simplicity in design. If only we did examine this closer to see where we went wrong, causing these engines to waste fuel, etc. The present design describes a better two stroke engine with new features added such as, VCR, VVT, and VFAR.

A new cam and follower engine needs to be modular to fit in multiple configurations while incorporating new features that have been difficult to implement, such as rear compression chamber on a multi-cylinder cam follower engine. The present invention describes a new design which solves this problem while incorporating new features like VCR, VVT and VFAR.

A good engine needs to have redundancy, fault tolerance, and load balance capabilities without additional complexities that comes with electronic solutions. The present solution seeks to solve this problem related to the lubrication system. The present design describes a remote oil distribution system that allows an engine like the ones described here, to have redundant oil supply passages handling more than one oil pump.

### BRIEF SUMMARY OF THE INVENTION

The present engine operates similarly to a conventional two-cycle engine. The similarity stops there. This two stroke engine does not waste fuel to the exhaust system. The fact is, it takes time for fluid to travel from one point to the next. This simple fact means we can use time to control the amount of exhaust and pressure left behind in the combustion chamber for scavenging and to increase the compression ratio for the next combustion event. As engine speed rises, the less time exhaust has to leave the combustion chamber. Therefore, we are able to keep more and more exhaust gases back in the combustion chamber as RPM rises, to be compressed for the next stroke, hence Variable Compression Ratio (VCR). It has become obvious that there must be a maximum pressure allowed so not to break the engine with too much pressure. It turns out that rear compression chamber from two stroke forced induction, produces roughly constant pressure at the end of each stroke. This pressure is now used as the maximum pressure allowed in the combustion chamber while the piston is at about Bottom Dead Center (BDC). This is achieved as follows: rather than pushing the fuel and air mixture through transfer ports near BDC as in a conventional two-stroke engine, the present engine uses air ducts to transfer the fuel and air mixture under pressure to intake valves located at about Top Dead Center (TDC). Now by removing the transfer ports from the present engine, the exhaust ports can be moved lower towards BDC. This increases the volume in the combustion chamber for higher compression ratio. Furthermore, the ports can be shorter by adding more of them near BDC to compensate for the short exhaust ports. This further increases the volume and compression ratio. The ports are distributed around the cylinder wall to allow for even heat distribution around the piston crown.

The present invention solves the issues with VVT as follows: Now that fuel and air mixture is pressurized and pushing on the intake valves, as soon as exhaust pressure in the combustion chamber falls below the inlet fuel and air pressure level, the intake valves open due to pressure difference, and the fuel mixture rushes in the combustion chamber while the exhaust ports are being closed, leaving no time for fuel mixture to reach the exhaust ports due to distance difference. As a result, the engine breathes at the right time, every time. No energy is lost during this operation. This engine is pressure-charged by using the underneath of one or more working pistons in the lower chamber or by using a separate air pump apparatus to compress the air or fuel and air mixture to push the intake valves open letting the air mixture to enter the combustion chamber under pressure. In the preferred embodiment, the intake valves are equipped with a pair of small magnet adapted to oppose another magnet mounted on the valve stem and in the valve support compartment so as to force the intake valve to remain shut when the engine is not running In other embodiments, the intake valves may be equipped with a small spring to force the intake valve to remain shut when the engine is not running This is to protect the valve and to keep the combustion chamber clean. A bracket or other means is used to secure the valve stem and its magnet piece secured, preventing the intake valve from falling in the combustion chamber.

The present engine design solves the issues with VFAR as follows: It has become obvious that a new process based on the simple logic that we can pour a rich charge mixture in a container, and then add more air later to that container to dilute the concentration which is the fuel and air ratio VFAR. It has become obvious that existing components of this engine can be used to create air pressure difference at the right time to achieve the right ratio based on throttle body position, this time without electronics. A partially open throttle valve creates a vacuum when the piston draws in fresh charge. That vacuum is later being used to suck in additional fresh air via a different port to dilute the charge, hence creating variable fuel and air ratio. A rear compression chamber which is the volume generally immediately adjacent to the piston, as described in rear compression two stroke forced induction, is sealed and connected with air ducts to the throttle body and intake valves. The lower end of the piston is used as a pumping mechanism for sucking in rich fuel and air mixture through a one-way valve which is located between the air ducts and the throttle body. The piston skirt has some ports on it to be uncovered by an adjacent cylinder or a cylinder operating inside the piston skirt to allow fresh air in the rear compression chamber to dilute the charge further. The throttle valve is open as wide as desired by the operator to allow the right amount of rich fuel and air to enter the rear compression chamber to produce desired power. During combustion stroke, the piston closes all ports and valves to compress the desired fuel and air ratio in the rear compression chamber where the charge is atomized and waits to enter the combustion chamber as soon as the pressure difference occurs to allow the charge to rush in the combustion chamber. The fuel and air mixture is atomized in the rear compression chamber by the sucking and compressing action of the pump.

The present design seeks to solve the issues with the pinging sound in most diesel engines, as follows: it is well known that fluid travels the path of least resistance. When applying this logic in a combustion chamber, it becomes clear that a way to solve this problem is to progressively decrease the volume of space available between the cylinder walls and piston crown, for gas expansion, starting from the axis of the cylinder. This will force the gases to first rush in about the axis of the cylinder during compression stroke to follow the path of least resistance. Once ignition occurs, a jet of gas will first shoot straight towards the center cavity of the piston crown to force it down, creating a lower pressure behind the jet of gas about the axis of the cylinder for other gases to follow, hence shaped charged combustion chamber. More than one cylinder can share the same conical hole forming a substantially Venturi shape at the center of their cylinder heads, allowing for gas expansion from both cylinders to travel towards the axis of one another.

The present invention solves the problem with efficiency as follows: As described in the VCR, VVT and VFAR section, the piston draws in new charge into the rear compression chamber through a one-way valve between the throttle body and the air ducts of the rear compression chamber. More air is allowed in via ports on the piston skirts. The wider the throttle valve is open, the less vacuum exists in the rear compression chamber, and the less air will be sucked in, causing a rich charge within for more power. During compression stroke, the pistons shut all valves and ports to compress the charge within the rear compression chamber. As the air pressure within the combustion chamber drops below the maximum level allowed, new charge is pushed into the combustion chamber, for compression and ignition. The exhaust pressure at about bottom dead center will determine how much fuel and air mixture in the rear compression chamber to enter the combustion chamber to be ignited due to pressure difference in both chambers. At idle, a leaner mixture with abundance of Oxygen will be found in the rear compression chamber for combustion, and the wider the throttle valve was open, the richer the mixture in the rear compression chamber will be, producing more power during combustion cycle to be more responsive when needed and to run leaner the other times. The rear compression chamber comprises of one or more air ducts connecting fuel/air mixture from the carburetor to the intake valves at about top dead center of the combustion chamber. The manufacturer can adjust how far the exhaust ports are located to achieve maximum power without wasting fuel since exhaust pressure will prevent extra fuel from entering the combustion chamber.

To solve the problem with excessive speed, the present engine uses the synergy of the solutions described for efficiency management to prevent the engine from running at excessive speed level. A remarkable feature of this engine is that it will run lean to slow down and protect the engine even if the operator presses down the gas pedal. This is because no new charges can enter the combustion chamber as a result of higher exhaust pressure left in the combustion chamber due to excessive speed.

The present engine is designed to allow air in and out with minimal effort. First, the air is drawn by the piston, and then went through the process described in VCR, VVT and VFAR. Some particular advantages of this design are the fact that exhausts backpressure helps to increase engine performance as opposed to conventional engines. Air moves in and out without complex apparatus like camshafts, springs, timing belts, etc, these require power to function. A turbocharger in a conventional engine causes backpressure that the piston has to push. A turbocharger in this engine causes backpressure that helps this engine to have a higher compression ratio and more torque.

The present engine solves the loud factor of the exhaust system in a particular way. The idea comes from emptying a water bottle. It is quieter when you dig a hole at the bottom allowing water to flow down without pulsing which is noisier. By adding a bypass air pathway to the cylinder exhaust ports, the vacuum behind the exhaust leaving the combustion chamber can be filled with air from the bypass pathways. This reduces the pulsating effect that causes air to vibrate creating frequencies that our brains interpret as noisy. The exhaust uses its own momentum and vacuum to leave the combustion chamber, causing this engine to be more efficient. The engine case is used as pathways for air being channeled from air filter housing to the engine case.

The present engine seeks to solve the problem of reaction torque with this new engine design. A stationary engine block is used with one or more offset cylinder from the center line of the engine axis. Two opposed pistons move coaxially within the offset cylinder, sharing the same combustion chamber. One cam follower is associated with each one of the opposed pistons. A cam plate with gears rotates about the axis of the engine, in one direction on one side of the engine block, parallel to the axis of the opposed pistons. Another cam plate, with gears, rotates about the axis of the engine, in opposite direction on the other side of the engine block and parallel to the axis of the opposed pistons. An endless cam track within each cam plate engages its respective followers to allow each one of the opposed pistons to independently reciprocate traveling towards bottom dead center then returning towards top dead center. The combustion event within the shared combustion chamber applies forces to both opposed pistons equally, then to the cam plates via the followers, finally to the engine axle. The reactive torque from each opposed piston is applied at equidistance, clockwise and counter-clockwise respectively on opposite end of the engine block, cancelling the reaction torque of the action torque applied to the axle. At least one engine axle with gears can engage the gears on the counter rotating cam plates. In a preferred embodiment, a planetary gear unit is used to engage with both cam plates. The axle and the sun gear of the planetary gear are the same; so the sun gear engages the pinions of the planetary gear unit. The ring gear engages the pinions of the planetary gear unit. The ring gear is fixed on one of the cam plates, turning in one direction, engaging with the pinion gears, while the other cam pate turns the pinions support component in the opposite direction. The cam follower is mounted directly to the piston skirt, or indirectly to the piston arm which is adapted to transfer their thrusts to the engine block or similar supporting body. Hydraulic pumps mounted in the piston arm component pumps oil in between moving related cam and follower components to distribute piston arm thrusts in all directions. The cam tracks are adapted to allow one set of opposed pistons to be at about TDC while the other set of opposed pistons to be at about BDC, producing a substantially straight line of torque output. Each combustion chamber forms a fully balanced reaction-free torque engine module with its own fuel delivery system, air intake and exhaust for load balance and redundancy in a box. Each piston skirt moves over one cylinder that forms a rear compression chamber connecting the throttle body to the intake valves at about TDC. This configuration allows for the working piston to compress the charge or some part of the charge in its downstroke in a volume other than that of the engine case. The rear compression chamber is sealed with a one-way valve between the throttle body and the working piston. There are ports on and near bottom of the piston skirt to allow fresh air to enter the rear compression chamber to dilute the charge within, for when the throttle valve is not fully open. This engine uses VVT, VCR and VFAR features to achieve optimum performance as described. The cam follower is relatively flat, collinearly shaped to the cam track forming a relatively small bearing with oil passages at the center to allow both components to hydroplane when moving. In the preferred embodiment, the return stroke cam profile is traced from golden spiral geometry, and the combustion stroke cam profile is curved to allow for constant moment arm length during downstroke producing a constant torque cycle.

The present invention seeks to solve the problems with piston side thrust issues related to reaction torque applied to a shaft or a cam plate. The goal is to have another mechanism to handle the side thrust forces rather than relying on the piston rings and skirt to bear the impact. The mechanism being described is a piston arm that is separate for ease of manufacturing, or it may form one physical piece with the piston. Bearings are used to allow the piston arm to slide on a solid surface area, in this case the engine block. The bearings are positioned to provide reaction thrusts in the opposite direction of that which is expected on the piston arm. As an example: if the piston arm is expected to push on a component on the left, the piston arm will be adapted, preferably with bearings, to provide reaction surfaces on the right. If the piston arm is expected to push against a sliding component pushing down from the top, the piston arm will be adapted to provide ground to push against, keeping the piston arm situated like a train on a rail. Lubrication is a big factor that is being solved with this invention. To reduce friction and help the bearing to last longer, a hydraulic pump is used in connection with the moving piston arm to provide lubrication and oil pressure that will allow the piston arm to glide on pressurized oil, hydroplaning. A pair of solid bearings is used to form a cavity in between to allow hydraulic fluid to be sucked in and compressed. Each one of the said bearings has an extruded section adapted so when mated together formed a substantially close cylinder. A cavity or port is located in one of the solid bearings to facilitate a one-way hydraulic valve to allow hydraulic fluid to travel one way in, and another way out. The hydraulic fluid is forced in between moving bearings of the piston arm to further distribute the side thrust equally in all directions. Excessive hydraulic pressure is quickly released along the way so not to cause damage during normal operations and during failure. Basically, the bearings serve like a cylinder with two sides. One side closes on end of the cylinder, while the other side closes the other end of the cylinder. A port is open on at least one side of the bearing so as to allow the hydraulic valve to let oil in and out. The advantages of this configuration is to allow quick release of extra pressure by temporarily split the two sided cylinder while at the same time producing more force to continue pushing on the component being pushed.

The present engine design seeks to also provide a better two stroke engine that is not operated with cam and follower, but conventional pistons rods, crankshaft in a sealed crankcase. A high compression ratio has been achieved the new VCR configuration and VVT operated by air pressure. This new design uses a single piston cylinder. A piston located within the cylinder housing forming a combustion chamber. At least one cylinder intake valve is located about TDC. A rear compression chamber which is a sealed crankcase links up with the intake valve and throttle body from a fuel metering device like a carburetor. Fuel and air mixture is sucked from the throttle body through a one-way charge valve located before the air intake valve, then into the rear compression chamber. A bypass port located in the crankcase is being opened by the piston skirt to allow fresh air in to fill in any partial vacuum left due to a partially opened throttle valve. This further dilutes the charge in the crankcase allowing this two-stroke engine to run lean whenever the throttle valve is not fully open. The bypass port in the crankcase is located right below the piston skirt when the piston is up at about TDC. During combustion stroke, the piston compresses the charge within the crankcase towards the intake valve located near TDC. The one-way charge valve by the throttle body is then closed due to air pressure difference. The intake valve is still closed during the combustion stroke. The bypass port in the crankcase is closed now as the piston moves towards BDC. The pressure of the charge gets higher while the pressure in the combustion chamber drops almost completely when the piston reaches BDC letting exhaust out through the exhaust ports. Pressure of the charge is now higher than the one in the combustion chamber. The charge pushes on the intake valve to rush in the combustion chamber and while the exhaust ports are being closed. The exhaust ports are closed before the inlet charge gets close to the exhaust ports due to distance and speed factor. The charge is mixed with exhaust left behind, then compressed to be ignited for the next cycle. Since no transfer ports are needed at about BDC, the exhaust ports can be smaller and nearer to BDC to allow for more room and higher compression ratio. More ports can now be located around the cylinder at BDC to distribute heat equally around the piston crown. More ports means shorter ports can be used to further increase the compression ratio. This works great for compression ignition like diesel. This design now incorporates a VVT powered simply by air pressure. As this engine speeds up, the less time the exhaust gets to leave the combustion chamber, causing exhaust pressure back in the cylinder. As long as this pressure is less than the inlet charge pressure, charges will continue to push the intake valve open to enter the combustion chamber. The faster the engine runs, the higher the pressure, the higher the compression ratio, hence variable compression ratio (VCR). The intake valve is equipped with means such as spring or a pair of magnets repulsing each other wherein one magnet piece is attached to the valve stem while the other piece of magnet is mounted in the valve stem support compartment to keep the intake valve floating or shut when not in use. The exhaust ports may be adjustable by means to be at times partially shut, allowing the operator to choose between more torque or horsepower wherein the closer the ports are open near to BDC, the more torque this engine will produce, and the wider the exhaust ports are open the more horsepower this engine may produce. A plurality of these two stroke engines may be adapted to share some common components including crankshaft, engine block, air intake and exhaust manifold.

The present engine is designed with modularity in mind. Each module comprises a combustion chamber with one piston. This modular engine solves the problem that was thought to be impossible to solve. It was thought to be impossible to have rear compression forced induction in an engine case that has multiple cylinders and combustion chambers. This has been achieved by implementing a cylinder served as a rear compression chamber, and connected to air ducts that are connected to the intake valve and the throttle body of the carburetor, to function within the piston. As illustrated, it's like having a cylinder inside a piston, inside another cylinder. This configuration has forced induction feature whereas a sealed compartment behind the piston bottom is used to pump air from the throttle body to the intake valve at about TDC. Each module is equipped with piston side thrust management allowing both action and reaction forces to be distributed in all directions. Two modules can share a combustion chamber and act as one engine with no reaction torque.

The present engine is designed with redundancy in mind. One of the safety factor of this engine is the remote oil distributor. Each moving part is coupled with a pair of bearings with oil being pushed in between for less friction and longer life. This engine is built with redundant oil path ways and redundant but distinct oil pumps. Should both pumps fail, critical moving parts are lubricated by oil splashing. This oil distributor has a base plate with adapters to connect hoses to and from an internal combustion engine or oil cooler. There is a valve and a spring within the plate. There are two main hoses from the bottom of the engine case: one for oil being pushed to the distributor by the primary oil pump. The other hose is for the hydraulic pump within the piston arm to suck in oil from the oil pan and bypassing the oil filters to be pushed in between the cams and followers to allow them to hydroplane during failure of the primary oil pump. The spring and valve within the base plate will be open to allow the hydraulic pump to suck oil bypassing the oil filters, should oil pressure drops. There are two oil filters screwed on the base plate for redundancy. During normal operation, oil goes through the filters than to hoses going back to the engine block for lubricating all moving components.

In short, this engine uses a cam and offset follower configuration while balancing the action and reaction forces produced during operation. Contrary to prior engines that are balanced with their followers travelling axially, this engine is balanced with offset followers. Much greater torque and horsepower are achieved with offset followers. This engine has hydraulic assist features with side thrust force redirection. This engine also employs a new method to achieve a quieter engine. This engine also features a shape charged combustion chamber. This engine is designed with an improved exhaust system. This engine is designed with load balancing, redundancy and fault tolerance. This engine features a relatively constant torque production.

### BRIEF DESCRIPTION OF THE DRAWINGS

FIG. 1A shows a configuration for cam curve and follower travel location to achieve maximum smooth torque and horsepower per size ratio.

FIG. 1B shows an optimum cam profile suitable for achieving optimum power to size ratio for an engine.

FIG. 2A shows a graph of a relatively constant torque produced by the optimum configuration of cam and follower as shown in FIG. 2B.

FIG. 2B shows a preferred configuration of two combustion chambers and their respective followers taking turn translating power on the cams to the output shaft.

FIG. 3 is a front view of the preferred embodiment of an engine using the methods and configuration illustrated in FIG. 2B.

FIG. 4A is an exploded view of the optimum cam profile and follower configuration being used in a bicycle.

FIG. 4B is a side view of a fully assembled bicycle as illustrated in FIG. 4A.

FIG. 4C is a front view of a fully assembled bicycle as illustrated in FIG. 4A.

FIG. 4D is a side view of a fully assembled bicycle as illustrated in FIG. 4A showing cams and followers working together on both sides of the bicycle.

FIG. 5 is a perspective view of a fully assembled one cylinder engine using the optimum cam follower configuration.

FIG. 6 is an exploded view of a modular engine unit showing oil paths and, air flow, and direction of forces involved.

FIG. 7 is a front view of an engine as illustrated in FIG. 3 depicting the direction of forces involved during the rotation of cam, follower and associated parts of the engine.

FIG. 8 is an exploded view of an engine block illustrated in FIG. 3 and some associated components.

FIG. 9 is an exploded view of a piston, piston bearings, follower and pre-compression chamber for the engine as illustrated in FIG. 3.

FIG. 10 is an exploded view of an engine block, piston bearings, piston valve assembly and hydraulic valve for the engine as illustrated in FIG. 3.

FIG. 11 is an exploded isometric view of an engine and its components as illustrated in FIG. 3.

FIG. 12A is a view of harness management and remote oil distributor unit of the engine as illustrated in FIG. 3

FIG. 12B is an isometric view of a remote oil distributor for the engine as illustrated in FIG. 3.

FIG. 12C is a front view of the remote oil distributor as illustrated in FIG. 12B.

FIG. 12D is a section view of the remote oil distributor as illustrated in FIG. 12B.

FIG. 13A is a side view of the fully assembled engine illustrated in the exploded view of FIG. 11.

FIG. 13B is a front view of the fully assembled engine illustrated in the exploded view of FIG. 11.

FIG. 14 is a full sectional view along the line of F-F from the front of the fully assembled engine as illustrated in FIG. 13B to show all major parts of the engine in their preferred alignment.

FIG. 15 is a full sectional view from the side of the fully assembled engine along the line D-D as illustrated in FIG. 13A to clearly show the internal structure of the engine.

FIG. 16A is a view of the relation between the components involved in the pre-combustion chamber.

FIG. 16B is a back view of the fully assembled engine as illustrated in the exploded view of FIG. 11.

FIG. 17A is a section view from the top along the line of G-G of the fully assembled engine as illustrated in FIG. 16B.

FIG. 17B is a section view from the top of the pistons center along the line of H-H of the fully assembled engine as illustrated in FIG. 16B.

FIG. 18 is an isometric view of the fully assembled engine components inside the case of the engine to show the redundancy of the lubrication system and cables.

FIG. 19 is a section view front of a two-stroke engine incorporating VCR, VVT, VFAR.

REFERENCE NUMERALS

| NUMBER | DESCRIPTION |
|---|---|
| 30 | Front case of the engine |
| 31 | Back case of the engine |
| 34 | Bearing supporting and covering pinions |
| 36 | Pinion gears |
| 37 | Planetary gear support base. |
| 38 | Bearing on planetary gear support interacting with engine |
| | block bearing. |
| 39 | Bearing in flywheel |
| 40 | Flywheel supporting cam and planetary gear |
| 41 | Oil meter rod |
| 42 | Bearing on flywheel holding planetary gear |
| 43 | Bearing in engine block coupled with axial components |
| 44 | Engine block |
| 45 | Bearing on engine block coupled with piston bearing |
| | supporting follower |
| 46 | Bearing on engine block coupled with piston side thrust |
| | bearing. |
| 47 | Glow plug |
| 48 | Cylinder air intake valve |
| 49 | Cylinder valve retainer |
| 50 | Cylinder valve spring |
| 51 | Cylinder valve bearing |
| 52 | Cylinder valve seat |
| 53 | Main injector |
| 55 | Air Compression Chamber/Exhaust component |
| 56 | Follower bearing |
| 57 | Air intake manifold |
| 59 | Cam component attached on the flywheel with planetary ring |
| | gear. |
| 60 | Flywheel supporting cam on opposite side of the engine. |
| 61 | Alternator unit |
| 63 | Bearing in engine block coupled with axial components on |
| | opposite side. |
| 68 | Screw securing alternator coil unit |
| 69 | Case covering dry compartment |
| 74 | Oil inlet coupling |
| 75 | Oil pressure valve |
| 77 | Pin to stop side thrust bearing mounted on engine block |
| | underneath side thrust piston bearing. |
| 78 | Pin to stop engine block bearing which is coupled with the |
| | bearing supporting the follower. |
| 79 | Air valve magnet |
| 80 | Air inlet valve |
| 81 | Oil pump base plate |
| 82 | Oil sump plug |
| 91 | Air inlet filter component |
| 92 | Alternator Magnet Unit |
| 93 | Axial clockwise screw |
| 94 | fuel tubes and electronic harness lines |
| 95 | Follower support bearing mounted on piston |
| 96 | Axial shaft bearing on shaft screw |
| 97 | Exhaust pipes |
| 98 | Hooks to support harness tubes |
| 99 | Piston |
| 100 | Bearing on shaft coupled with planetary gear cover bearing |
| 101 | Axial shaft |
| 102 | Axial shaft screw counter clockwise |
| 103 | Bracket for managing harness |
| 104 | Harness bracket gasket |
| 105 | Optional injector |
| 106 | Bearing for side thrust on piston. |
| 107 | Pump pressure cap |
| 117 | Oil pipe coupling |
| 110 | Oil pump cover |
| 111 | Oil pump pin |
| 112 | Oil pump inner gear |
| 113 | Oil pump outer gear |
| 114 | Cam component attached to flywheel not supporting the |
| | planetary gear |
| 116 | Hydraulic Oil check Valve In Engine Block |
| 120 | Remote oil distributor housing. |
| 121 | Oil filter on remote oil distributor |
| 200 | Bicycle frame |
| 201 | Bicycle tire |
| 202 | Cam groove |
| 204 | Cam Follower assembly cover |
| 205 | Chainwheel attached to the cam body |
| 206 | Bicycle chain driving chainwheel, freewheel, and derailleur |
| 208 | Pedal axle |
| 209 | Crank arm |
| 211 | Follower |
| 212 | Pedal |
| 213 | Cam and Follower assembly cover on opposite side. |
| 215 | Cam support plate |

### DETAILED DESCRIPTION OF THE PREFERRED EMBODIMENTS

A preferred method for translating reciprocating motion into rotary motion using a cam and follower mechanism to achieve maximum torque and power per size ratio will now be described. This method can be adapted for use with an internal combustion engine or a bicycle among other types of apparatus.

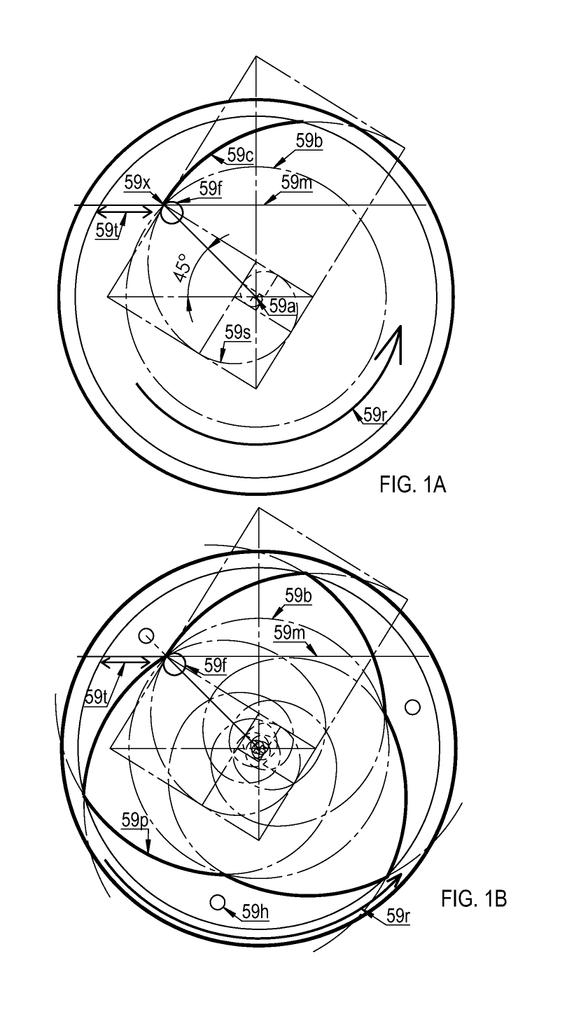

It may be pure coincidence that the intersection of what is considered to be divine or golden geometries forms the basis of a method to translate reciprocating motion into rotary motion. However, referring now to the drawings: FIG. 1A illustrates that related golden geometries meet at one intersection point 59x.

There are many ways to describe where to locate the follower travel path and direction, but the destination remains about the same. Below is how the follower path and cam profile was determined for a specific torque and power requirements:

A 45 degree angle line from a moment arm and shared axis will intersect the line of action at the base circle of a cam, whose profile can be traced over a golden spiral sharing the same center to achieve maximum torque and power per size ratio.

Another way to describe where the cam profile and follower travel is as follow:
1) Draw your moment arm vertically from an axis 59a.
2) Draw a line of action 59m horizontally to meet the desired torque requirements.
3) Draw a 45 degree angle line from the axis of the moment arm to intersect the line of action 59m at 59x. A golden angle sharing same axis and parallel to line of action may be used to indicate the center of dwell at top dead center.
4) Draw a cam base circle 59b from the same axis 59a to intersect point 59x.
5) Draw a golden spiral 59s with the diagonal lines of its golden rectangles being horizontal and vertical respectively, and the intersection of both diagonal lines to intersect the center of the base circle 59b.
6) Start tracing the first cam profile curve 59c at intersection 59x and over the golden spiral 59s towards outside base circle 59b.
7) Mirror curve 59c about the 45 degree center line.
8) Follower 59f can now travel about 59t of the line of action 59m to start interacting with the curves of the cam at about the intersection 59x from within base circle 59b.
9) The travel distance of the follower is proportional to the amount of cam dwells and curves used around the base circle 59b.

FIG. 1B illustrates a cam profile with three inversed lobes or periods based on the golden spiral. Notice how the solid double lines of the cam profile 59p follow the curves of the mirrored spirals. Dwells may be introduced between curves. A slightly different curve may be used with this cam follower travel location configuration. Cam support apertures 59h may be located at the center of the widest part of the cam side. Cam rotation 59r shows the direction of the cam rotation during operation for maximum power.

This cam profile and follower travel location or configuration is an optimum location for maximum power to size ratio. This cam profile configuration allows the follower to push on the cam during power or combustion stroke while allowing the cam to push the follower back to the initial starting point of the latter during return or compression stroke. The angles of the curves may be changed slightly. However, it will soon be noticed that some significantly small changes will cause the follower to wobble and lose its feature of being pressed against one direction during both combustion and compression stroke. This cam follower mechanism allows for high speed operation. This is different from a disk cam since no external mechanism or gravity has to retract the follower to its initial position during normal operation. This cam profile allows for multiple followers to take turn independently translating linear motion into circular motion. This allows for multiple followers to overlap while taking turn translating linear to circular motion at different location on a continuous 360 degree curved cam profile. This overlap is taken advantage of during exhaust operation. In a two stroke operation when the exhaust event is taking place, the other follower at an opposite or different location has just started its turn pushing on the cam helping to achieve constant torque. The force magnitude is virtually constant since the air starts expanding at ignition while the space in the cylinder starts expanding at the same time. Deflagration is possible in some cases, and less noise will then be created. Therefore, a constant force magnitude plus a linear line of action produce constant torque.

It may look counter intuitive for the follower to push out about 59t on the cam profile as illustrated in FIG. 1A. It is as if the follower is a door knob being pushed. One would expect the cam to turn clockwise. However, the angles of the curves make all the difference as to the direction of the cam rotation. In this case, the follower pushes in the same direction with the cam rotation 59r which will increase horsepower. This configuration allows for time to be borrowed from compression stroke and be given back to combustion stroke for gases to have enough time to be burn, resulting in a cleaner engine. This cam configuration allows the follower to travel about the same direction with the cam rotation without jamming to increase horsepower. This cam configuration also allows the cam to rotate in reverse without jamming. FIG. 1A illustrates the starting point 59x of a follower 59f in relations to the starting point of a cam profile curve 59c. A follower 59f travels about 59t of the line of action 59m chosen to meet torque and horsepower to size ratio requirements.

FIG. 1B illustrates cam profile 59p which is traced or made from golden spirals and mirrors of golden spirals. The travel distance 59t of the follower is proportional to the number of lobes and dwells forming the cam profile circle. The outstroke of the cam starts at about the intersection point 59x and ends at the intersection of the cam dwells or mirrored golden spiral. A dwell may be introduced between outstroke curves and return stroke curves of the cam profile. The follower in this configuration is pushed between the cam profile 59p and a support surface area parallel to the follower travel path both during power stroke and compression stroke. This works like jamming a chisel in a cavity in a rock to split it open. This configuration helps to prevent the follower from wobbling during normal operation. This cam follower configuration allows for maximum torque and horsepower while allowing the follower to stay in constant contact with the cam at high speed to translate or convert reciprocating motion into rotary motion. This cam follower configuration allows for constant rate of change of acceleration during power stroke at least. This allows for smooth operation. A cam profile based on oval circles may be used to achieve a similar cam profile to that of a golden spiral. A golden angle may be used in addition to the mentioned 45 degree angle that intersects the line of action and cam base circle in order to locate the center of an optimum dwell curve at the top dead center position.

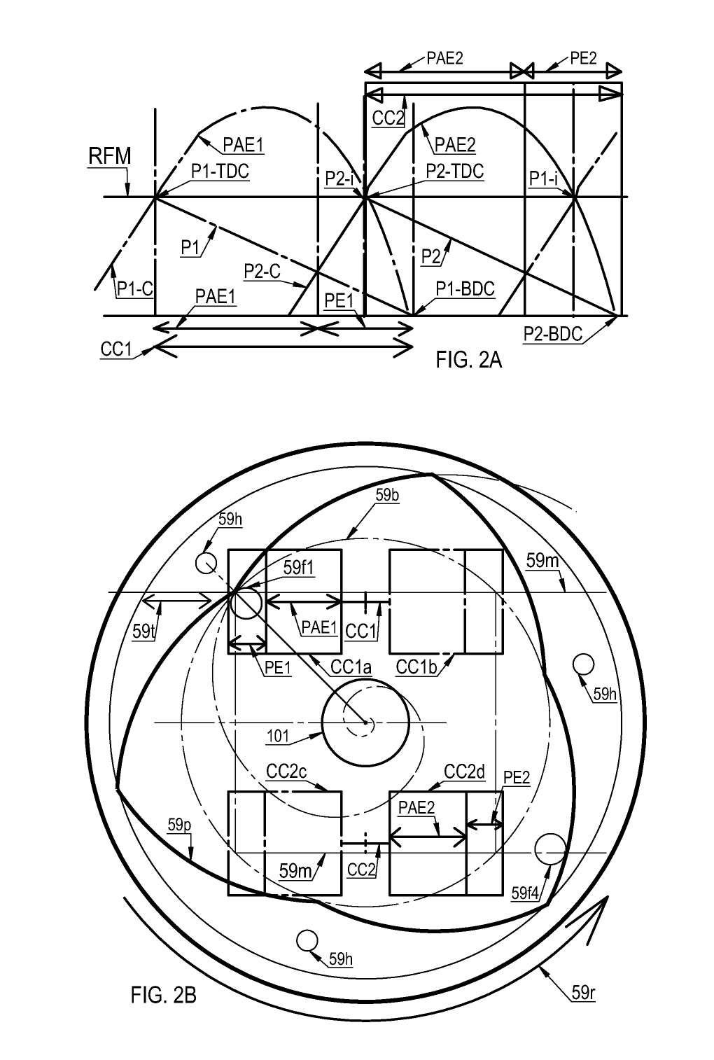

FIG. 2A is a chart showing timing of two combustion chambers in this preferred embodiment. The dotted lines represents combustion chamber one CC1. The solid lines represent combustion chamber two CC2.

P1 and P2 respectively represent pistons in CC1 and CC2.
P1-C and P2-C respectively represent piston compression in CC1 and CC2.
P1-i and P2-i respectively represent ignition event in CC1 and CC2.
P1-TDC and P2-TDC respectively represent piston at top dead center.
PAE1 and PAE2 respectively represent piston air expansion in CC1 and CC2.
PE1 and PE2 respectively represent the uncovering of the Exhaust port in CC1 and CC2.
P1-BDC and P2-BDC respectively represent pistons at bottom dead center.
RFM represents resultant force magnitude for both CC1 and CC2 combined.

As the air expands in each combustion chamber, the related pistons drop increasing the spaces available for hot air to expand. Therefore, a relatively straight line of resultant force magnitude is plotted for each combustion chamber. FIG. 2B illustrates a cam profile with two followers: 59f1 and 59f4. While 59f1 is at a top dead center position, 59f4 has not reached its bottom dead center yet. This overlap is used to maintain pressure in at least one combustion chamber at about all times.

Notice how PE1 overlaps with PAE2 in FIG. 2A. Likewise, notice how PE2 overlaps with PAE1 in FIG. 2A. These overlaps mean while air pressure in one combustion chamber is dropping due to exhaust event, the other combustion chamber air pressure is rising due to ignition event in the latter. Therefore, a relatively straight line of resultant force magnitude can be plotted for both combustion chambers. Since this engine produces a relatively straight line of resultant force magnitude acting on a straight line of action 59m, this engine produces a relatively constant torque during its two stroke cycles.

FIG. 2B also illustrates a preferred embodiment of an opposed piston configuration per combustion chamber. Combustion chamber One CC1 comprises of two identical combustion chambers: CC1a and CC1b. Combustion chamber two CC2 comprises of two identical combustion chambers: CC2c and CC2d. Fuel is injected in the middle of both CC1 and CC2. There are two cams in this preferred configuration, one in front and one in back. More details will be provided in later drawings. CC1a and CC2d interact with the front cam while CC1b and CC2c interact with the back cam. Both front and back cams are identical and attached with bolts 59h or other means to their respective flywheels or cam plates which counter rotate to translate power and torque to the shaft or axle via transmission gears.

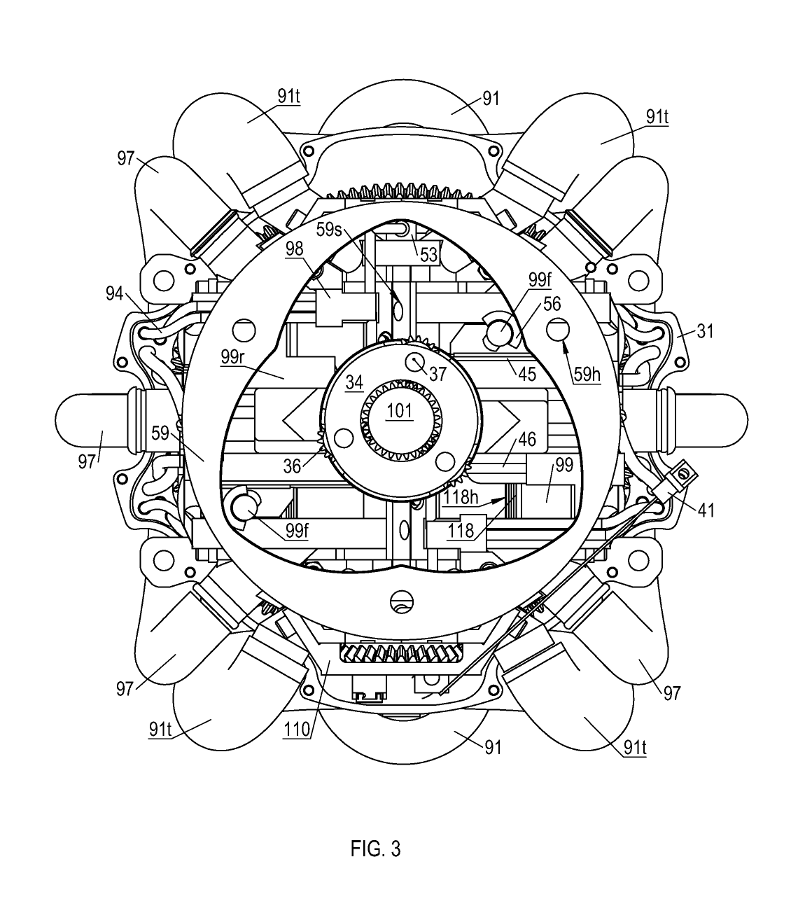

FIG. 3 illustrates the preferred embodiment of my engine with the front case and front flywheel removed to show key components mentioned above. A planetary gear pinion 36 can be seen with a sun gear 101 at the center. The sun gear also serves as the engine axle or shaft. The gears 36 are mounted on planetary gear support base component 37. FIG. 3 will be exploded later to reveal more details about it, but the following is a brief description of what you are looking at in this figure: The air intake filter 91 is attached to the air intake tubes 91t supplying air to the combustion chambers. Fuel injectors 53 inject fuel at the center of each combustion chamber. Once ignited, hot air expands pushing pistons 99 at opposite ends away from each other. Bearings 56 serve as followers mounted on follower support arm 99f which is an extension of the piston skirt. The piston arm 99f and bearing 56 are pushed against the cam 59 in constant contact as the piston glide back and forth on a bearing 45. A side thrust arm 99r is an extension of the piston skirt on opposite side of the piston arm 99f. The thrust arm 99r is used to counter the side thrust exerted on the piston as it pushes on the cam on the other side. Four identical pistons and their respective followers are used in this embodiment: two on top facing each other at opposite ends, two at the bottom positioned likewise. Two followers interact with the front cam 59 while the other two followers interact with the cam on the back. As the hot air from the combustion stroke expands in combustion chamber one CC1, both of its pistons are pushed away from each other. One of these pistons pushes on the front cam while the other piston pushes on the back cam. At the end of the combustion stroke, exhaust ports are open to let exhaust gases escape to exhaust manifolds 97. While the front cam and back cam counter rotate, their movements are synchronized and balanced by either the planetary gear, oil pump gear interacting with both front and back flywheels supporting their respective cam, the equal pressure exerted on opposite pistons, or by all three of these factors. Oil pump cover 110 helps to support the oil pump to be described later. The oil meter rod 41 helps to monitor oil level in the engine. Oil is squirted out from holes 59s in the engine block helping to lubricate the cam. Piston rings 118 are exposed briefly on the side 118h at about bottom dead center. Particles caught between the piston rings are flushed out by exhaust gases. The ends of the piston rings are fixed away from the exhaust holes and openings 118h to prevent them from getting stuck in the holes 118h or exhaust ports.

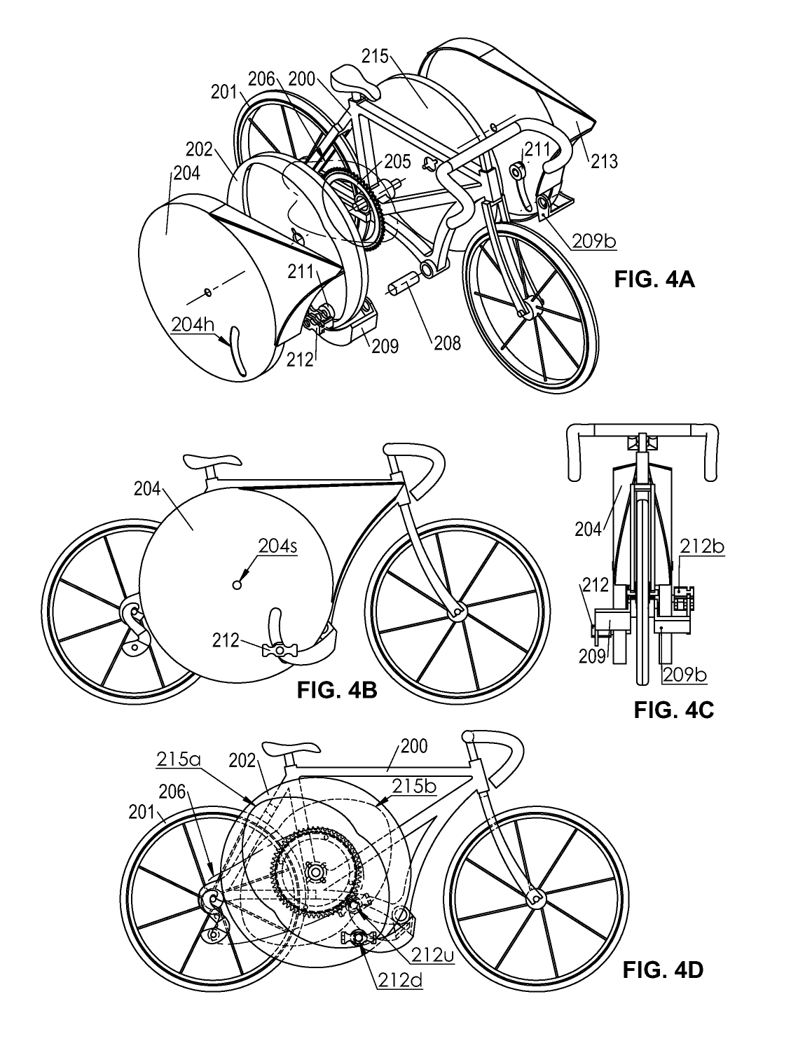

An optimum way to convert reciprocating motion into rotary motion is ideal for human powered devices. FIG. 4A illustrates the use of my cam follower configuration. The bike frame 200 is modified to support my cam follower mechanism. Bicycle tires 201, chain 206 and other standard bicycles components remain the same, lowering production cost and implementation. Cam 202 and its support plate 215 are mounted to the bicycle's main hub. The chainwheel component 205 attached to the cam support plate. Pedals 212 and followers 211 are attached respectively to crank arms 209 on one side and 209b on the other. Two cam profiles may be mounted on both sides of a cam support plate. The crank arms 209 and 209b are attached to the frame 200 and pivoting around axle 208. A cam follower assembly cover 204 and 213 are used to cover the moving parts and to be aerodynamic. A hole 204h is adapted to allow the followers 211 to reciprocate.

FIG. 4B is a side view of a fully assembled bicycle in FIG. 4A. The cam follower cover assembly 204 is secured to the frame via 204s.

FIG. 4C is a front view of a fully assembled bicycle in FIG. 4A. The cam follower components and assembly cover 204 are relatively slim which is suitable for aerodynamics. The crank arms 209 and 209b support the pedals 212 and 212b outwardly to facilitate the weight transfer of the operator towards the follower. The weight of the operator is applied on the pedals and is balanced between the crank arms and the cam profile. Therefore, most of the weight is translated into the rotary motion.

FIG. 4D is a side view of a fully assembled bicycle in FIG. 4A with the cover 204 removed and the cam profiles 215a and 215b on both sides of the frame 200 shown to illustrate their operation. Both profiles are locked with each other. As profile 215a is coupled with pedal 212d at a down position, profile 215b is coupled with pedal 212u at an up position. The diameter of the cam is as wide as possible to allow maximum torque to be applied on the attached chainwheel then to the wheel 201 via chain 206.

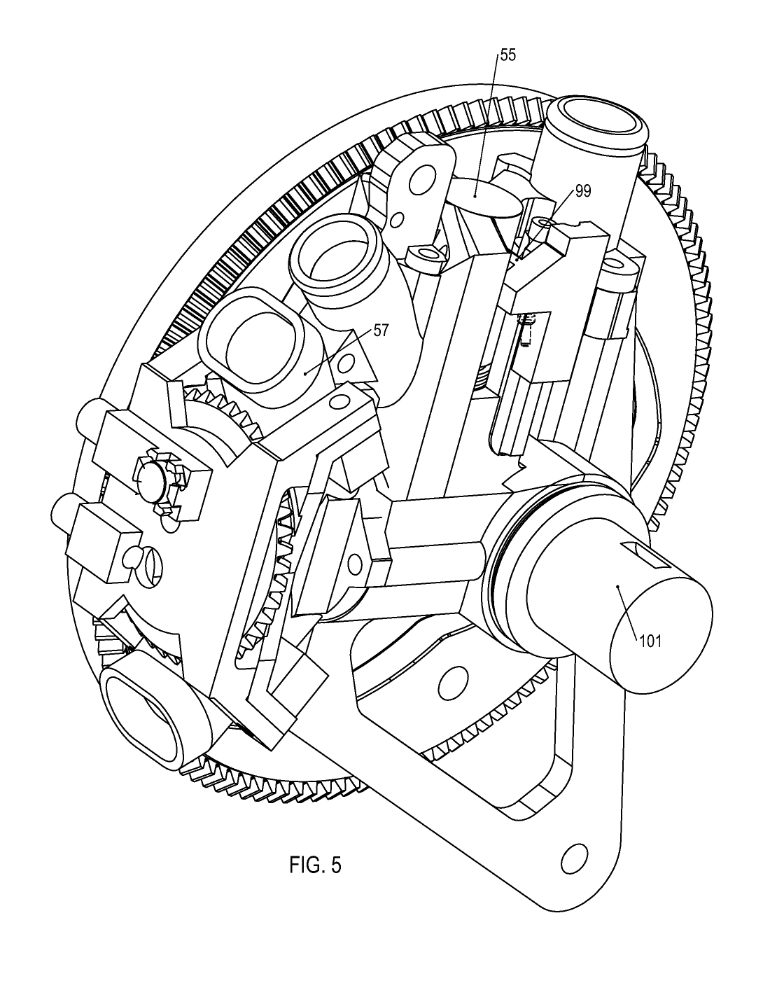

FIG. 5 illustrates an isometric view of a much simple one cylinder engine using my cam follower mechanism. The pre-compression chamber 55, the air intake manifold 57, the piston 99 and the axle or shaft 101 are shown to illustrate a fully assembled engine.

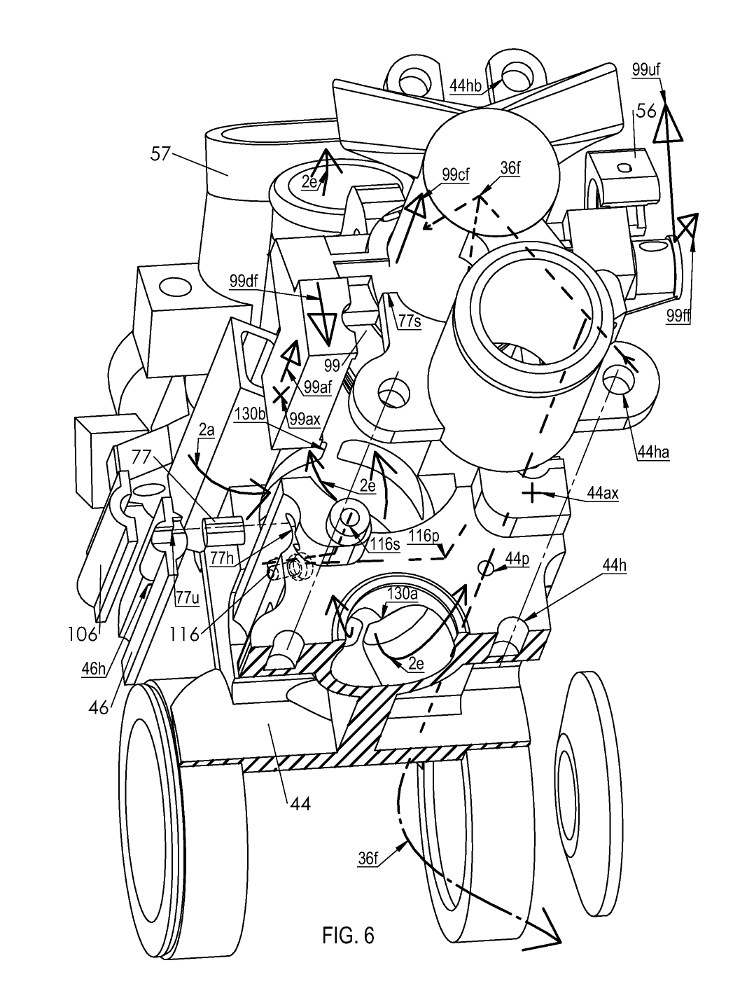

FIG. 6 is an exploded view of a modular engine illustrating air intake 57, exhaust 2e, lubrication 36f, hydraulic systems 116, 116s and 116p, in relation to each other in a compacted space, and finally side thrust force redirection from 99af, 99df to 99uf and 99ff. This figure can also be used to better explain the exhaust system. As exhaust 2e exits the combustion chamber, a back lower pressure normally created in conventional engines is now filled with fresh air 2a circulating in the engine case. This helps to create a constant stream of exhaust with relatively low air pulsation or interruption at the exhaust ports. Less exhaust pulsation magnitude helps to smooth oscillation of air pressure at frequencies that our ears and brain does not interpret as sound. This helps to create a quitter exhaust system. The aerodynamics found in the exhaust manifolds and ports 130a help to streamline the exhaust with minimum turbulence and pockets of low pressure. The principle involved works like digging a hole at the bottom of a bottle being held upside down while being emptied. Less noise is created, and the bottle is emptied the quickest. As the exhaust 2e is channeled towards exhaust ports 130b, air 2a enters from the side of the combustion chamber to backfill the vacuum that would normally be created by the exhaust fluid leaving the exhaust ports while the piston going up towards top dead center closes the exhaust ports. In my engine module, side air 2a goes around the piston skirt towards the exhaust ports to fill the vacuum before audible air pulses or noise is created. While the principle involved is well known, applying this principle before high audible air pulses are created at the source of an exhaust system is new with my engine.

Side thrust force redirection is achieved using offset forces and hydraulics. The side thrust 99af is offset from the center axis 99cf of the piston 99. As the piston moves forward, a down force 99df is created, twisting around axis 99ax which is a bearing 106 gliding and squeezing hydraulic fluid in groove 46h. As 99df goes down, the follower support 99uf is twisted up about axis 44ax which is an extruded planar face on the engine block. Also, as the piston moves towards bottom dead center, it squeezes hydraulic fluid through a tunnel 116p drilled from one side of the engine block 44 to the other side. The hydraulic fluid distributes pressure in all direction, pushing the follower support forward 99ff. Hydraulic fluids help to balance forces all around. Bearing 106 attaching to the piston 99 on one side is coupled with bearing 46 mounted on the side of the engine block. A pin 77 is used to secure bearing 46 to the engine block. The pin 77 is inserted into cavity 77h drilled on the side of the engine block. A cavity 77u in bearing 46 is used to prevent ping 77 from exiting the engine block. Also extrusion 77s is used to prevent ping 77 from dropping out the engine block. Hole 77h is bigger than pin 77 to allow 77s to push and lock pin 77 underneath 77u. Hydraulic fluid is sucked in between bearing 106 and 46 in cavity 46h via oil channel 116s. A check valve 116 prevents hydraulic fluid from returning the same channel 116s while allowing the hydraulic fluid to be pushed through channel 116p to the other side of the engine block to push the follower support 99ff forward.

Lubrication is achieved via oil channels 36f. A hole 44p is drilled through the engine block towards the axial bearings for oil to cool the engine block and lubricate the axial bearings. Holes 44ha on pre-compression chamber component is used to secure it to the engine block via hole 44h. Screw holes 44hb are also used to secure the pre-combustion chamber component to the engine block. The piston glides on a cushion of fluid as the hydraulic fluid is being pumped between the bearings of the piston to redirect forces to the follower 56. This engine module in FIG. 6 allows for replication of itself to form a bigger engine. The engine module balances action forces with reaction forces using the cam and center block or axle of the engine.

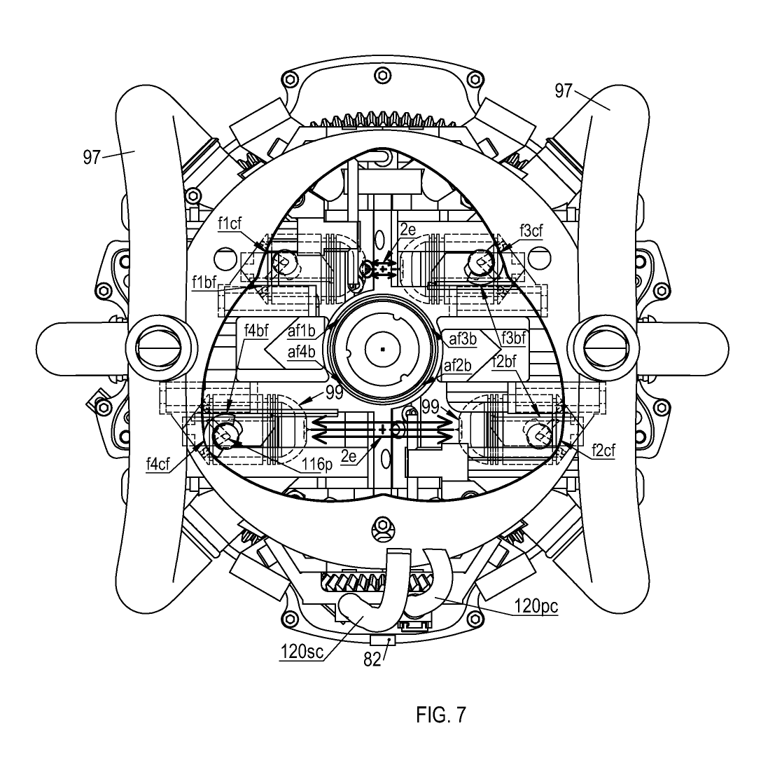

FIG. 7 illustrates force distribution during operation of my new engine. In this preferred embodiment, the pistons are opposed to each other forming one combustion chamber. Pistons 99 are highlighted with broken lines to show their location in respect to each other during operation. The forces involved in FIG. 7 are balanced in a triangle way. Force on surface f3cf is between a front cam and follower mounted on the front side of the engine block. Force on surface f3bf is between the engine block and the front follower support. Force on surface af3b is between a front cam support plate and the engine block. As illustrated, F3cf, f3bf and af3b form a force triangle on the top front side of the engine. Force on surface f1cf is between a cam and a follower mounted on an opposed piston on the back side of the engine block. Force f1bf is between the engine block and a follower support on the back side of the engine block on the opposed piston. Force on surface aflb is between a cam support plate on the back side of the engine block and the engine block. As illustrated, f1cf, f1bf and af1b form a force triangle. Similarly, Force f4cf, f4bf and af4b form a force triangle on bottom front side of the engine block, while force f1cf f2bf and af2b form a force triangle on the bottom back side of the engine block. Air flow 2e represents air compression and expansion. The exhaust pipes 97 are optionally joined in the middle, to both combustion chambers, to facilitate exhaust from one combustion chamber to draw air from the other combustion chamber like a Venturi effect. The exhaust pipes 97 may be crisscrossed. Oil flow 116p of FIG. 7 shows the flow of hydraulic fluid going through the follower support and the follower to the cam profile. Oil pipe 120pc is used to eventually push oil to the engine block for cooling and lubrication. Oil pipe 120sc is used as a backup line for the hydraulic system to eventually suck oil from in case of an oil line, oil filter or pump failure. Oil plug 82 is used to plug oil sump hole used for oil change.

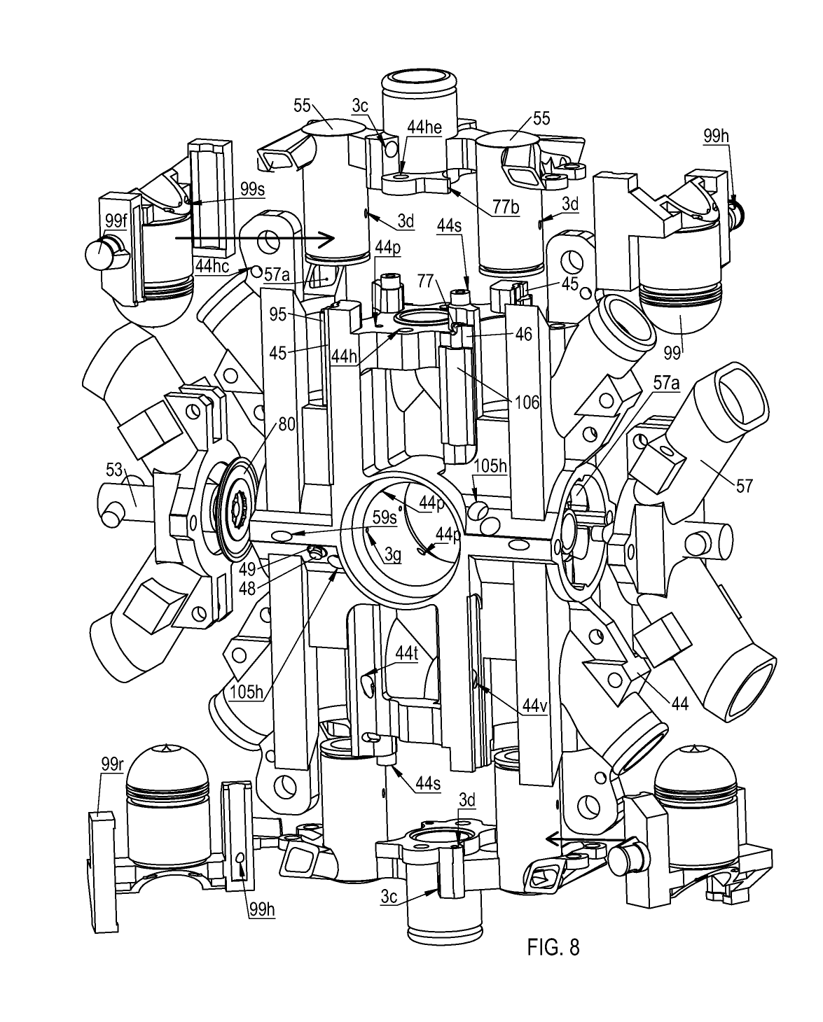

FIG. 8 is an exploded view of the main components attached to my engine block. The air compression chambers 55 is made to function like an immovable piston or cylinder operating inside of a movable piston 99 forming an air compression chamber. As the piston 99 moves in one direction it compresses the air in the combustion chamber. As the piston 99 moves in the other direction, it compresses air in the compression chamber 55. The air 57a is channeled towards air intake manifold 57. Screw holes 44he on the air compression chamber component are used to secure this component to screw hole 44h on the engine block 44. The pistons 99 are inserted inside the cylinder in the block 44. Then the immobile piston or compression chamber component 55 is inserted inside the pistons 99. Cylinder bearing are mounted on the immobile piston of 55. Bearing 106 is partly inserted in the sidebar thrust arm 99r of the piston to slide on top of bearing 46 which is partly inserted in the side of the engine block. These two bearing form a closed cylinder to draw in hydraulic fluid from hole 44s through hole 44t, then to be pushed to hole 44v on the other side of the engine block. This hydraulic fluid now enters bearing 45 through a cavity in this bearing, facing hole 44v. Bearing 45 is partly inserted on the side of the follower support 99f of the piston to slide on top of bearing 95 which is inserted partly inside the engine block. These two bearing form a closed cylinder allowing hydraulic fluid to enter this cylinder to redirect forces from one side of the piston skirt to the other side that pushes the follower support 99f forward. From this cylinder, hydraulic fluid is forced through hole 99h to exit in between the cam and follower to create hydroplaning effect. Pin 77 resides partly underneath bearing 46 which resides underneath bearing 106 which in turn resides underneath the side thrust sidebar 99r of the piston. Extrusion 77b from the compression chamber component helps to keep pin 77 locked underneath bearing 46 which is now locked to the engine block. The air inlet valve 80 resides inside the air inlet manifold 57, allowing fresh air to be drawn to the compression chamber and then be pushed to the combustion chamber when the piston reaches about bottom dead center. Air flow 57a represents the passages of air within the engine block. As the pistons draw in fresh air, a weak vacuum is created in the compression chamber at very high revolution. Ports 99s is used to fill up the vacuum at about the last moment to be closed right when compression starts. As exhaust gases leave the combustion chamber, air pressure difference causes the compressed air to rush in the combustion chamber as soon as possible and from the center top of the combustion chamber to flush exhaust gas out and fill up the combustion chamber with fresh air. Sideway air inlet ports may also be used close to the exhaust ports as ways to inject fresh air to the combustion chambers. A four cycle configuration is possible with an axial cam operating exhaust and intake valves. However, in my preferred embodiment, valve 80 is used to allow one way air flow from manifold 57 to chamber 55 and back to push cylinder valve 48 to enter the combustion chambers. Fuel injectors 53 are mounted in the manifold 57 to supply fuel to the combustion chambers. Alternate fuel sources and glow plugs are located in the side holes 105h on the engine block. Holes 44hc on the engine block are used to support and secure the engine cases. My new engine is cooled and lubricated by oil being pushed from an external source and going through hole 3c intersecting drilled holes 3d within the compression chamber 55 to lubricate and cool piston 99. Same oil from external sources is channeled through hole 44p which is drilled all the way to the axial bearing hole 44m. At this location, this oil is used to cool and lubricate axial bearings. A hole 59s is also drilled on the side of the engine block up to cavity 3g, allowing the same oil lubricating the axial bearings to also lubricate the cylinder valves 48 and exiting hole 59s to finally splash on the cam on both sides.

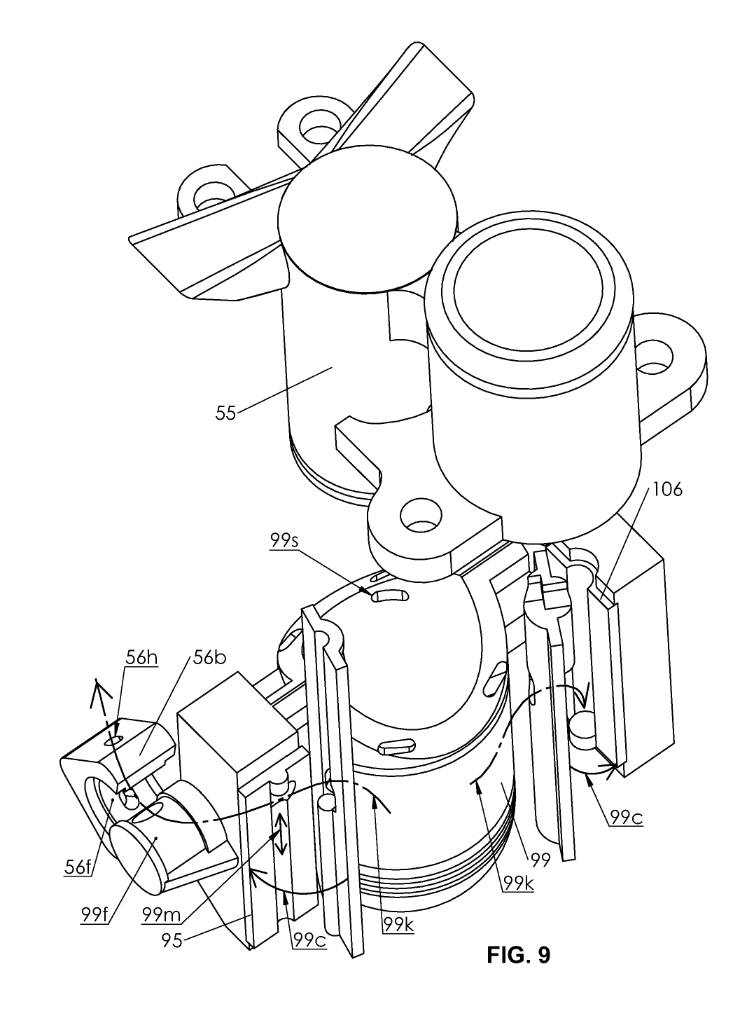

FIG. 9 represents the piston assembly. The compression chamber 55 is inserted inside a cylinder in the piston 99 that is adapted to form a compression chamber. Piston bearings are coupled as illustrated with 99c to form a closed cylinder allowing hydraulic fluid to enter as indicated with hydraulic flow 99k. The movement 99m represents hydraulic flow within the cylinder formed by the closed bearings 99c. 56h illustrates a hole at the center of the follower which is served as bearing acting on the cam. Hydraulic fluid is forced through hole 56h to allow the follower to hydroplane. Cavity 56f is cut slightly wide enough to snap on and be prevented from falling out of cam support 99f allowing the bearing 56 to rotate within limits. Cavity 99s also serves as oil escape holes.

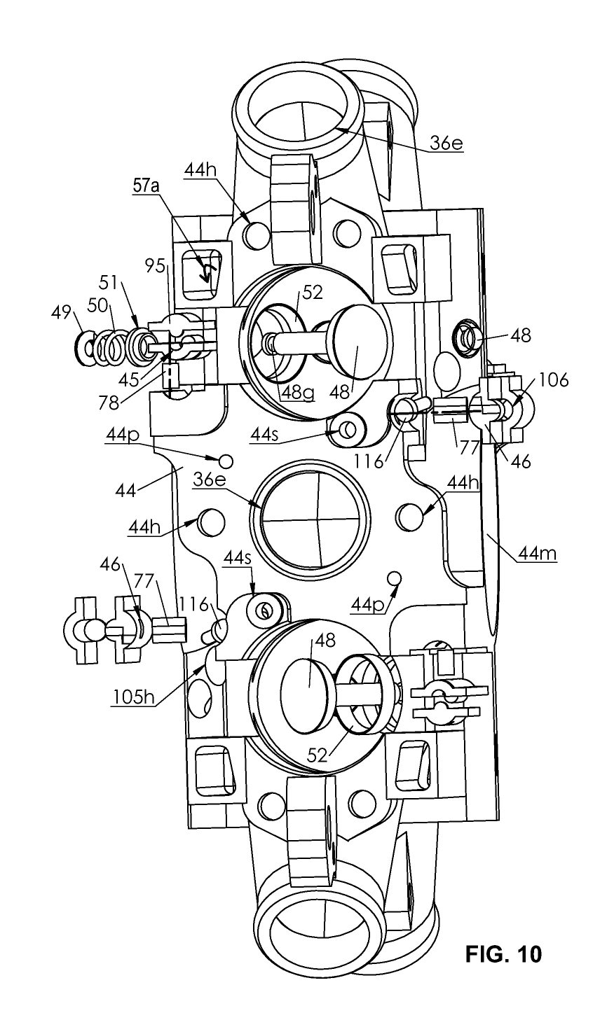

FIG. 10 shows an exploded view of the preferred embodiment of my engine block with valves and bearings for the purpose of showing their installations. Cylinder valve seats 52 are pressed inside the cylinders from the inside of the engine block 44. The cylinder valve assembly comprises of a cylinder valve 48 which has a groove 48g. One end of the valve 48 is inserted through the valve seat 52 and appeared on the outside of the block 44 allowing for a valve bearing 51 to be inserted into the engine block from the outside of the block. Valve 48 glides within bearing 51 during normal operation. A relatively small spring 50 or magnet is used to push the valve 48 at an almost closed position and allowing for air pressure difference to dictate when the valve should be opened or closed with minimum resistance. Bearing 51 is inserted from the outside of the engine block and is locked in its cavity to prevent the spring 50 and retainer 49 from being pushed inside the engine block. A cylinder valve retainer 49 is inserted into the groove 48g securing spring 50, bearing 51, and valve 48 within the engine block. Bearing 95 coupled with bearing 45 which is secured to the engine block via pin 78. Pin 78 is inserted into the engine block to prevent bearing 45 from moving forward. Bearing 95 is normally inserted partly inside the follower support 99f which is the component preventing bearings 95 and 45 from falling out. Pin 77 is inserted into the engine block to prevent bearing 46 from being pushed out. A hole 44m for the axial bearing is drilled at the center of the engine block. In this figure, hole 44p is better shown, and is drilled up to hole 44m for lubrication. Hole 44s is used by the hydraulic bearings or side thrust bearings 106 and 46, forming a cylinder of a pump with a check valve 116 to suck in hydraulic fluid through to be pushed to the inside of the cylinder formed by bearings 45 and 95. Therefore the pistons move on a cushion of fluid or hydraulic bearings. Air flow 57a helps to cool the engine block during normal operation. Screw holes 44h are used to secure the compression chamber component to the engine block.

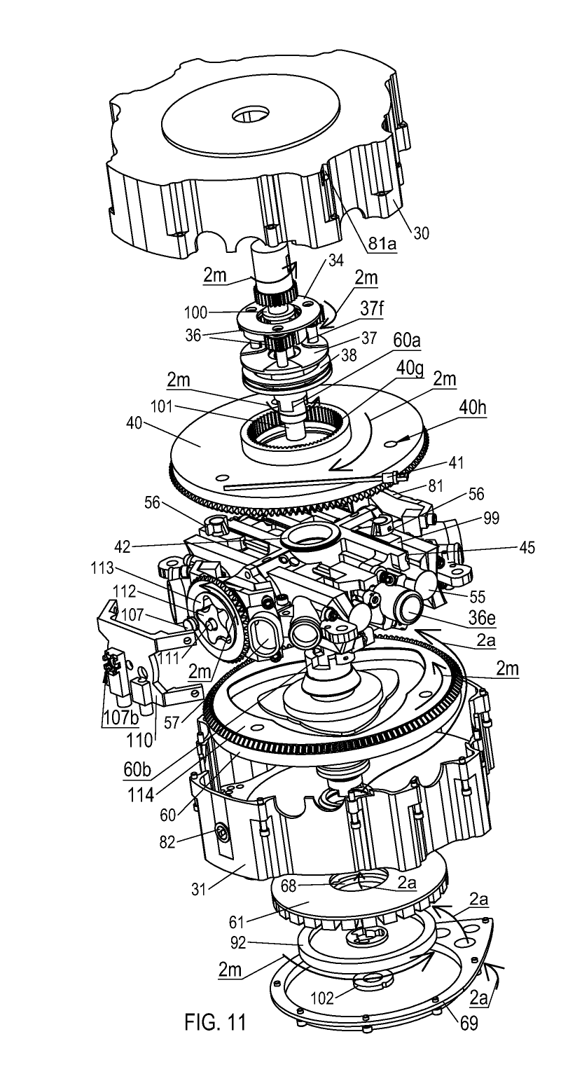

FIG. 11 is an exploded view of the main components of the engine within a front case 30 and a back case 31. Motion arrow 2m shows the rotation of the respective components. Air flow arrow 2a shows air circulation within the engine case which is eventually sucked out via exhausts manifold 36e. Bearing 42 is mounted at the center hole 44m and allowing a flywheel support component 40 to be rotated with minimum friction. Planetary gears 36 are mounted on a planetary support component 37 to turn against ring gear 40g on flywheel 40. Main axle 101 is turned much faster than flywheel support component 40 which is done as a result of the planetary gear reduction and the counter rotating flywheels turning the pinions in opposite direction from the planetary gear support. This results in more horsepower. The followers travel along the line of action and at about the same direction. The piston travel distance is less than the distance traveled by the flywheel circumference. This also increases total horsepower. Flywheel 40 supports the front cam, which is identical to cam 114, via fastener hole 40h. Bearings 38 are used to lessen friction between the planetary gears support component 37 and flywheel 40. Bearing 100 is used to lessen friction between axle 101 and planetary gear cover bearing 34. A hole 37f is drilled on the support component 37 to allow oil to go through axial bearings from center hole 44m in the engine block to lubricate pinions 36. Hole 81a in the front case 30 is used to insert oil meter rod 41. Injector support plate 81 is used to secure the main injectors. Follower bearings 56 are attached to extrusion 99f on the piston skirt. The follower may be attached to the piston indirectly. Followers 56 take the shape of the cam profile allowing both cam and follower to glide on each other during operation. Follower 56 bearing may be circular or oval. When one side of the follower 56 is worn, it can be removed and rotated so the other side can be used as new since the follower component is symmetric. The piston 99 glides on bearing 45. FIG. 11 shows the relations and how pre-compression chamber 55, exhaust 36e, air intake manifold 57, oil pump, are respectively input and output components sandwiched within two flywheel plates 40 and plate 60. Oil pump components are exploded to better illustrate its internal components in relation to the engine. Oil pump outer gear component 113, inner gear 112, and pin 111 are sandwiched between base plate 81 and cover case 110 which are fastened to the engine block. Cavity 107b is used to secure oil pressure release valve 107. Cavity 60a is coupled with cavity 60b to lock planetary gear support 37 with the back flywheel 60. A main nut 102 is screwed on axle 101 tying in both flywheels 40 and 60, planetary gear support components, engine block and axial bearings, and an optional axial alternator component 92, all together. An optional alternator coil 61 is fastened to the outside case 31 with nut 68. Back case plate 69 is used to seal and keep dry components placed outside the engine case 31. Air flow 2a goes through holes within case plate 69, around alternator components for cooling, through axial air ducts within case 31 and adapted to allow air in, but keep oil from spilling out.

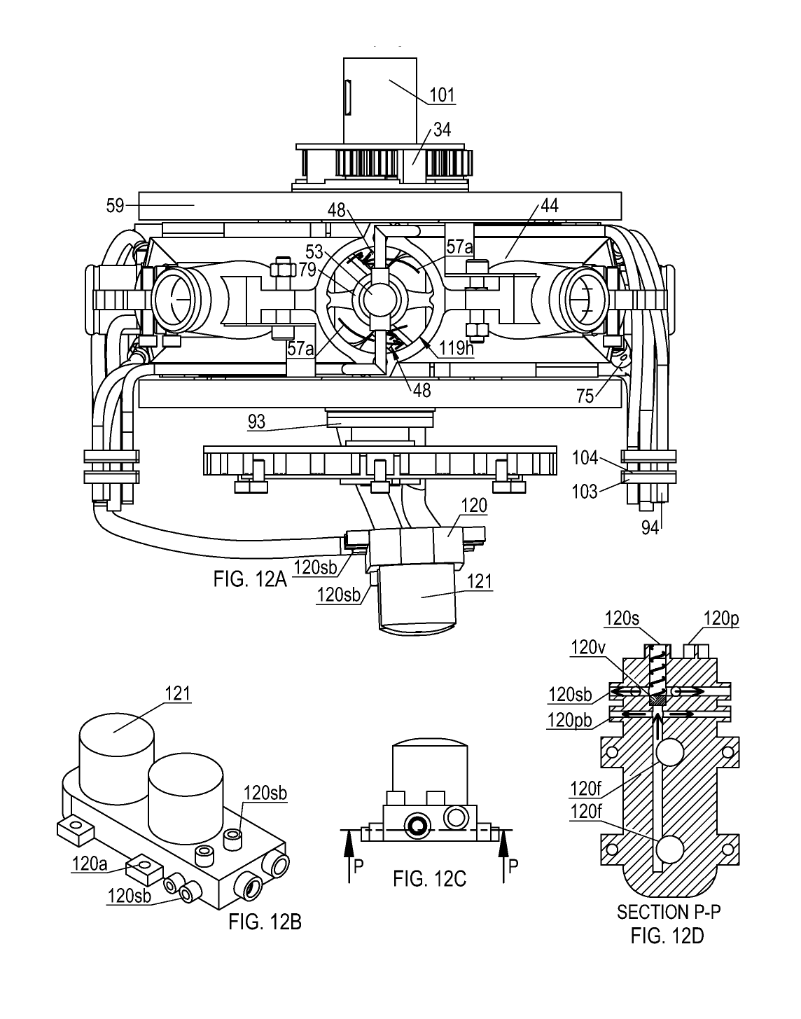

FIG. 12A illustrates wiring harness of cables and pipes 94 attached to injector 53 and fuel pipes for the injectors. Each injector has its own electronic cables and fuel supply cable for redundancy. The cables or pipes 94 are secured to the engine case using brackets 103 and gaskets 104. A remote oil distributor FIG. 12B may be used to manage oil flow and oil filtration. Oil filter 121 is screwed on base 120. Two filters are used for redundancy. Aperture 120a is used to secure oil base 120 to other components or the car body. Apertures 120sb are used to provide oil to the hydraulic pumps formed by the piston bearings 106, engine block bearing 46, and check valve 116. Apertures 120pb are used to push oil to the engine block, piston skirts, axial bearings, and pinions. Oil pressure in engine block is regulated by pressure release component 75, which may be monitored with remote gages. Component 75 is redundant, with one mounted on each side of the engine block. FIG. 12C is a front view of the remote oil distributor. An oil cooler component may be attached to the remote oil distributor. FIG. 12D is a section view of the remote oil distributor component. The oil is pushed from the oil pump to aperture 120p which is connected to the oil inlet section of both oil pump filters. The oil exits the oil filters via apertures 120f to push its way to the engine block cavities through aperture 120pb. Oil exiting filters 121 via apertures 120f also pushes on valve 120v to supply hydraulic fluid to the hydraulic pump formed by the piston bearing 46 and 106. Axle 101 acts like a big bolt using nut 93 to tie in planetary gear, both flywheels and engine block. These components are screwed tight enough to allow them to turn freely without jiggling. Air flow 57a in FIG. 12A is compressed in aperture 119h then enters the combustion chamber by pushing on the cylinder valve 48. A special feature of this engine is that at the end of the combustion stroke, the exhaust ports are revealed and the momentum of the exhaust push itself out of the combustion chamber. The momentum of the piston is used towards intake compression and powering the cam providing more power. The closer the piston gets to bottom dead center, the more compressed the air in chamber 119h gets. This allows the air intake to enter the combustion chamber at the optimum time to flush exhaust out at high speed and at perfect timing. This timing is accomplished simply with pressure difference between chamber 119h and the combustion chamber due to time spent with exhaust ports open while piston 99 is near bottom dead center. A magnet 79 is used to float the air inlet valve 80 at equilibrium.

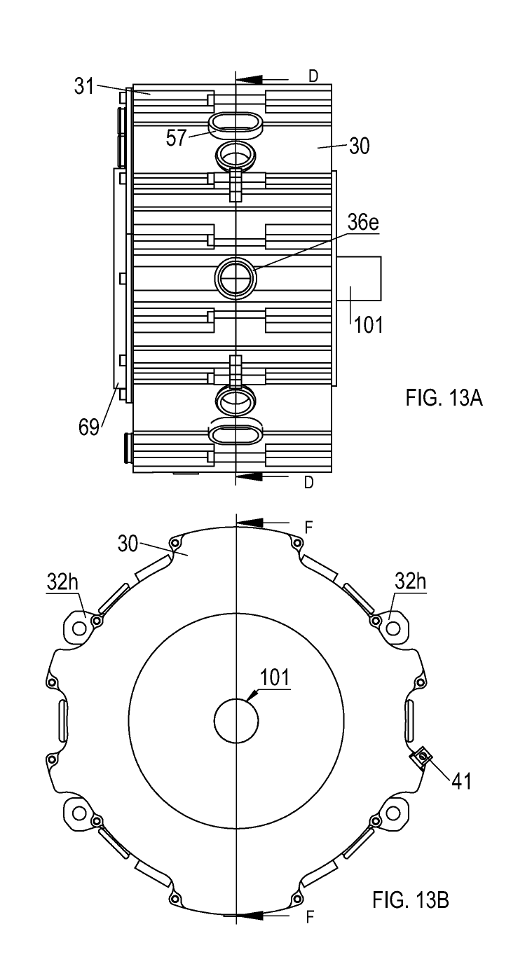

FIG. 13A is a side view of my new engine. Air inlet manifold 57 and exhaust 36e are shown. Multiple pathways are used for redundancy. Front case 30 and back case 31 are fastened to the engine block and sealed to each other. The axle 101 is sealed within the center of the front case 30. Back cover case 69 is used to seal other components in a dry compartment of the back case 31.

FIG. 13B shows a front view of my new engine. Engine handles 32h are used to secure the engine block to other components or the car. Oil meter rod 41 is inserted on the side of the case to meter the oil level while maintaining a low profile within a relatively spherical shape. Axle 101 may be made water tight to allow the engine to run under water.

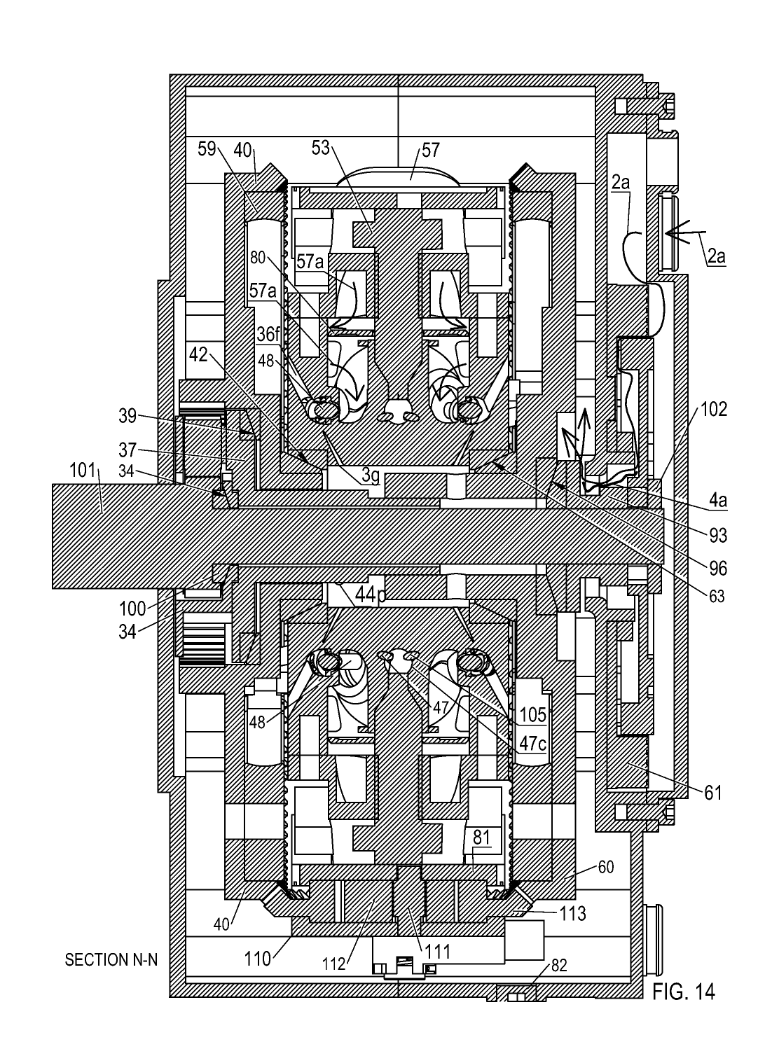

FIG. 14 is a sectional view of my new engine. This figure illustrates air flow 57a entering aperture 119h where air valve 80 resides to allow air to be sucked to compression chamber 55 then be pushed on cylinder valve 48 to enter the combustion chamber. The injector 53, glow plug 47 and optional side injector 105 share a smaller cylinder between the two combustion chambers forming a pre-combustion chamber 47c. Ignition occurs first in this pre-compression chamber where fuel mixture is richer. The hot gas rushes out both directions towards the center of the cylinders and pistons. This initial faster gas motion at the center creates a lower pressure at the center of the combustion chamber and pistons. Gases near the side walls of the cylinder rush in following the initial gas motion from the pre-combustion chamber 47c. This creates a shape charge effect. This relatively dome combustion chamber is coupled with cylinder valve 48 that complements the dome shape of the combustion chamber. A relatively dome piston head helps to squeeze air in the combustion chamber to achieve high compression ratio in a smooth concave dome combustion chamber. A relatively dome piston head also helps to prevent expanding gases from splashing on the piston head returning from bottom dead center. This helps to create a much quitter engine. Plus the piston dome helps to progressively channel hot gases towards the exhaust ports and achieve an aerodynamic exhaust system. The piston head may contain a concave hole or other weave shape cavity to help absorb the force of the combustion event. The pre-combustion cylinder chamber 47c is curved with the smallest diameter being at the center. This helps to guide the expanding gases from ignition event towards the center of the combustion chamber. A special feature of my engine is the synergy of these related features. Section view N-N of FIG. 14 shows oil hole 3g drilled to lubricate cylinder valve 48 and its bearing. A bigger hole 59s is drilled on the side of the block for oil to escape and spray the cam profile. Lubrication enters the axial bearing chamber via hole 44p. Oil is pushed through cavities between components to lubricate bearing set 42, 39, 34, 63, and 96. Main nut 93 is used to secure flywheel 40 and 60, planetary gear holder 37. Bearing 100 is mounted on main axle 101 to lessen friction between adjacent components. Nut 102 is used to secure rotatable alternator magnet. Air duct 4a is adapted with peaks and valleys to allow air to enter the engine case to cool the engine block while preventing oil from spilling out. Oil pump base plate 81 is secured on the engine block holding oil pump outer gear 113, inner gear 112 and oil pump pin 111. Oil pump cover plate 110 is used to channel oil to the remote oil distributor base 120. Oil sump plug 82 is used for emptying dirty oil through. Air flow 2a goes through axial alternator coil 61 and air duct 4a to enter engine case 31.

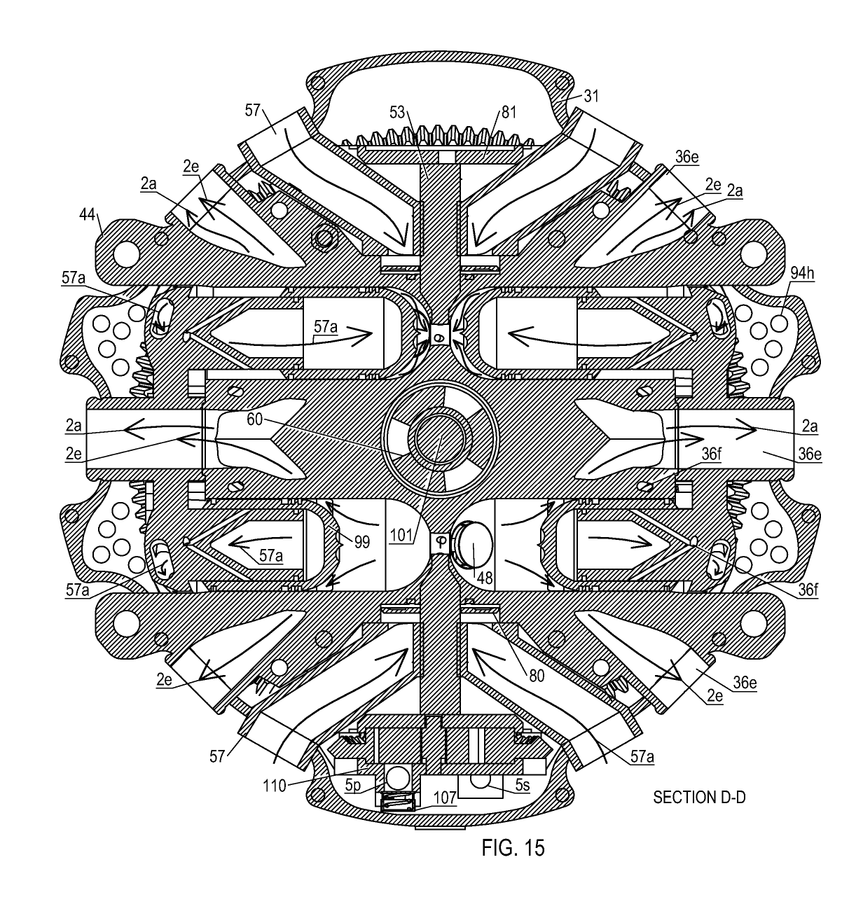

FIG. 15 is a front view cross section. It illustrates air flow and exhaust flow between both combustion chambers. The top combustion chambers illustrate air rushing in air intake manifolds. The air intake 57a is sucked in compression chamber to enter the inner cylinder of the piston. As the piston moves towards top dead center, air flow 2a within the engine case enters the exhaust system to fill the vacuum created by the exhaust 2e leaving the combustion chamber. The bottom combustion chamber illustrates pistons 99 at the bottom dead center. Air intake 57a is compressed and pushes on valve 48 to flush exhaust 2e out exhaust pipes 36e. Aperture 5p on oil pump cover 110 is used to push oil out to the remote oil distributor base 120. Should oil pressure rises too high within the oil pump, pressure valve 107 is used to release oil back to the oil sump. Aperture 5s is used as a backup means to allow hydraulic pump formed by bearing 106 and 46 to suck oil directly from the oil sump. During normal operation, this backup line is closed by valve 120v in remote oil filter base 120. Should a blockage occurs within the oil filter or should the oil pump stop working, oil goes through a backup line from aperture 5s to enter remote oil distributor 120s to exit aperture 120sb towards the engine block aperture 44s. Harness apertures 94h on harness bracket 94 are used to support wires and pipes coming out of the engine case 31. Oil holes 36f are drilled in the engine block and compression chamber to help cool piston 99 and engine block 44.

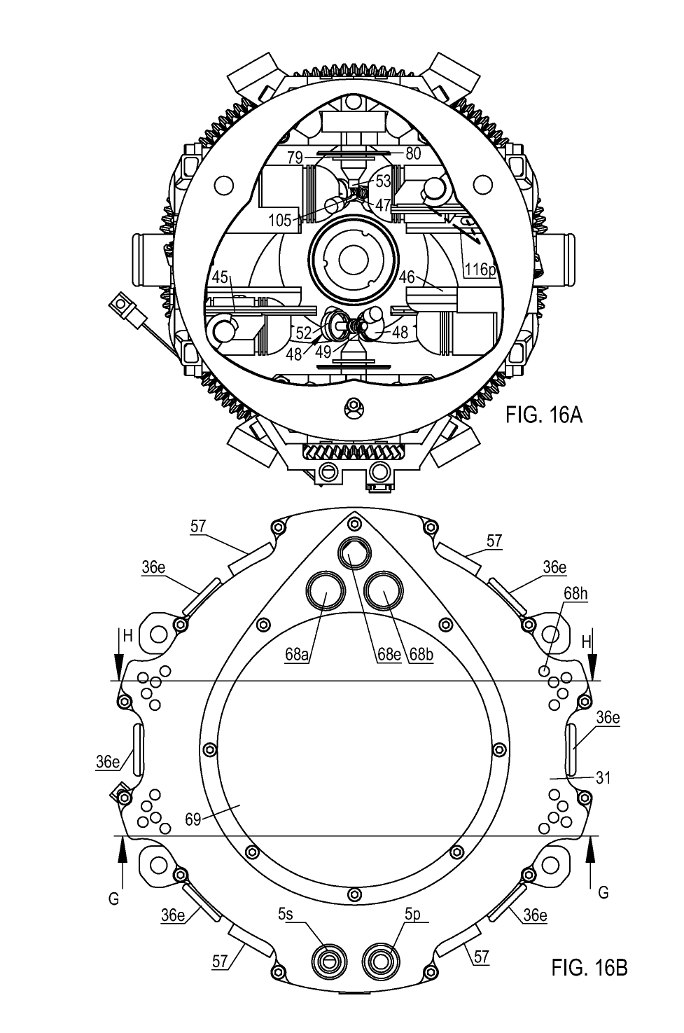

FIG. 16A shows the pistons, followers and cams in relation to each other. Line 116p illustrates hydraulic fluid being pushed from the hydraulic pump on the back side to the follower in front. The main injector 53, the side injector 105 and side glow plug 47 are triangularly facing each other within the pre-combustion chamber. As illustrated in this figure, two followers translate their actions with the front cam while the other two translate their actions to the back cam. A smaller cam profile is carved on the flywheel to return the follower to its proper location during engine shutdown and startup. Magnet 79 may be used to keep valve 80 floating at equilibrium.

FIG. 16B illustrates back view of my engine. Holes 68a and 68b are used as backup air holes coming from behind the air filter. These holes are used to allow fresh air to circulate through engine components and exit via exhaust pipes. Hole 68e is used to insert electronic cables through. Therefore, four cables or pipes (fuel, air, exhaust, and electronics) can be attached to this engine from above water to allow this engine to run under water.

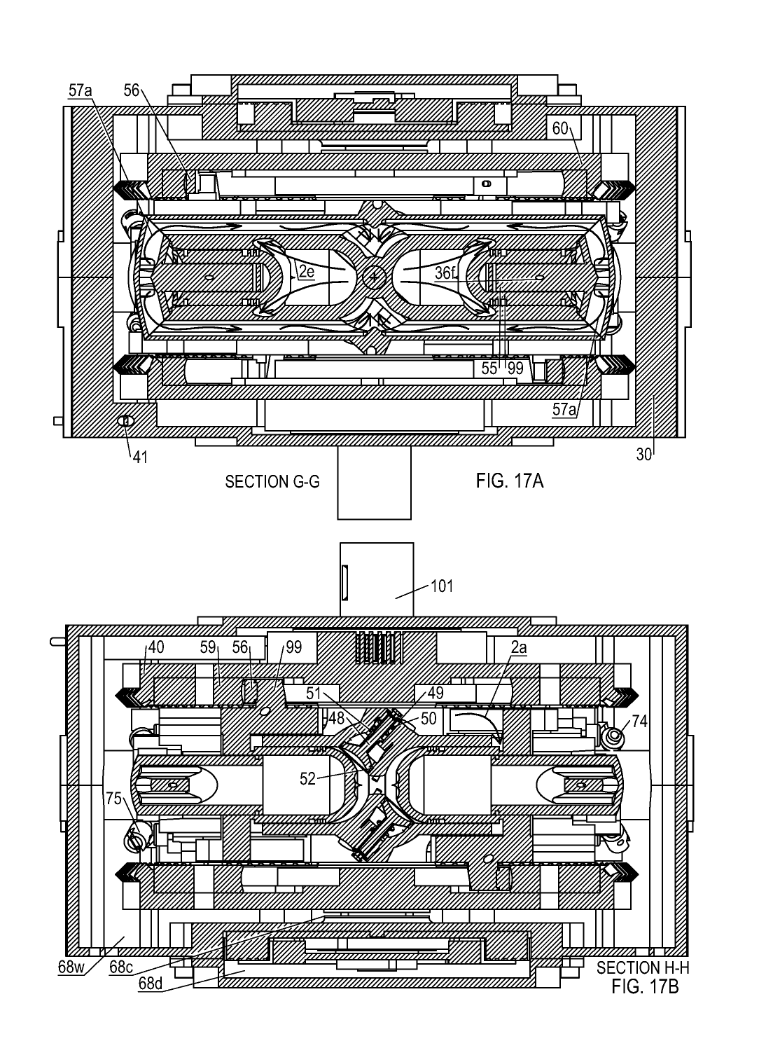

FIG. 17A illustrates air intake passages from compression chamber 55 to aperture 119h showing air flow 57a. While exhaust 2e exits the combustion chamber, air inlet is being compressed and pushed through the cylinder valves to enter the combustion chamber. FIG. 17B illustrates a section view at the center of the pistons and combustion chambers. This view shows the symmetry which exists all around. Air flow 2a goes around the piston skirt at about the center of the case in a way to prevent oil from spilling through the exhaust ports. Air flow 2a shows how air enters the exhaust ports from the side of the engine block to fill the vacuum created by the exhaust. This vacuum contributes to the air being vibrated at a frequency that our brains consider to be noisy. By filling up this vacuum at the exhaust port, the air vibration is dampening. Oil pressure valve 75 and oil inlet coupling 74 are redundantly fastened to the engine block. Orifice 68c is used to allow air in but keep oil from being spilled out of the case. An oily section 68w is sealed to allow oil to splash around. A dry section 68d is sealed to allow air to throughout while keeping oil out. FIG. 17B shows how cylinder valve 48, valve seat 52, valve bearing 51, spring 50, and valve seat retainer 49 are mounted within the engine block.

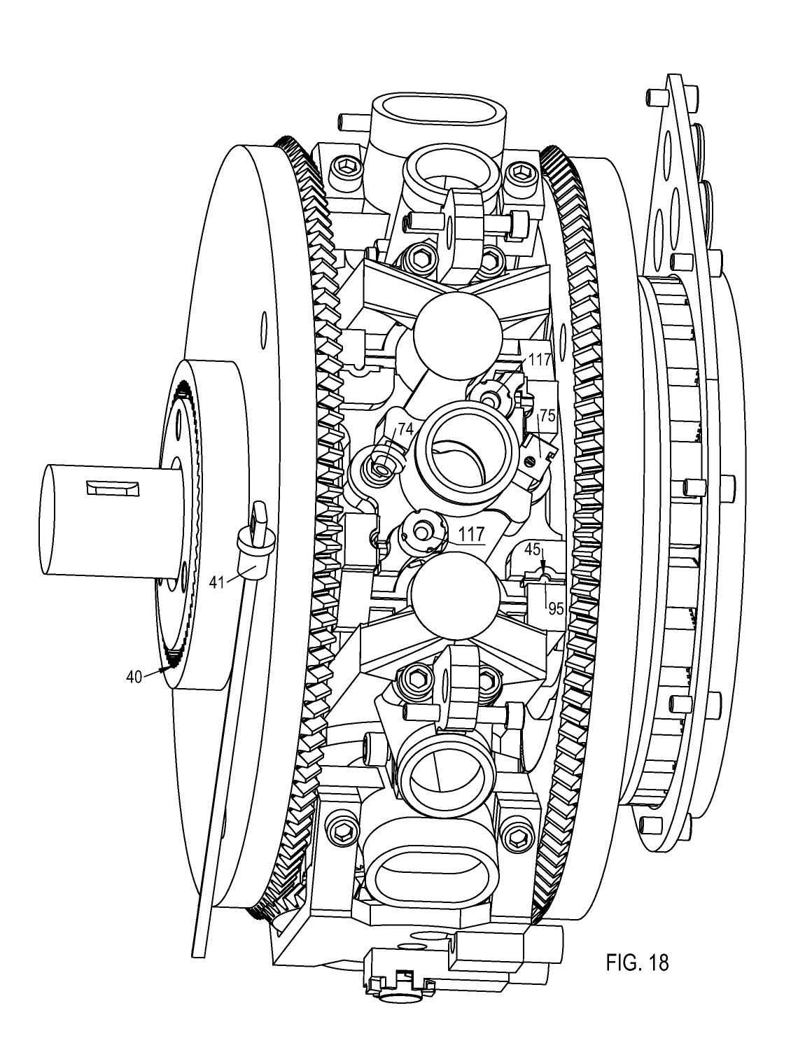

FIG. 18 shows an isometric view of my engine with the cases removed to display internal components. Fasteners 117 are used to attach oil pipes to the engine block to be used by the hydraulic pumps. The follower support mounted on the piston skirt glide on a cushion of oil between bearing 45 and 95.

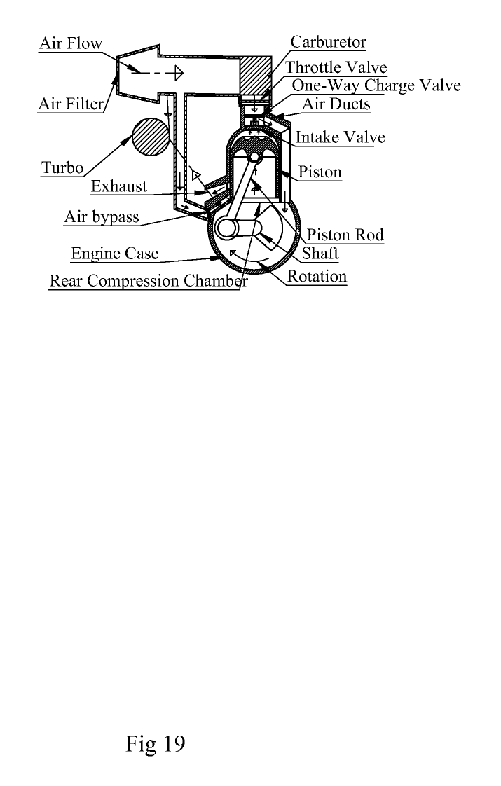

FIG. 19 shows a front section view of a better two stroke engine that is not operated with cam and follower, but conventional pistons rods, crankshaft in a sealed crankcase. A high compression ratio has been achieved the new VCR configuration and VVT operated by air pressure. This new design uses a single piston cylinder. A piston located within the cylinder housing forming a combustion chamber. At least one cylinder intake valve is located about TDC. A rear compression chamber which is a sealed crankcase links up with the intake valve and throttle body from a fuel metering device like a carburetor. Fuel and air mixture is sucked from the throttle body through a one-way charge valve located before the air intake valve, then into the rear compression chamber. A bypass port located in the crankcase is being opened by the piston skirt to allow fresh air in to fill in any partial vacuum left due to a partially opened throttle valve. This further dilutes the charge in the crankcase allowing this two-stroke engine to run lean whenever the throttle valve is not fully open. The bypass port in the crankcase is located right below the piston skirt when the piston is up at about TDC. During combustion stroke, the piston compresses the charge within the crankcase towards the intake valve located near TDC. The one-way charge valve by the throttle body is then closed due to air pressure difference. The intake valve is still closed during the combustion stroke. The bypass port in the crankcase is closed now as the piston moves towards BDC. The pressure of the charge gets higher while the pressure in the combustion chamber drops almost completely when the piston reaches BDC letting exhaust out through the exhaust ports. Pressure of the charge is now higher than the one in the combustion chamber. The charge pushes on the intake valve to rush in the combustion chamber and while the exhaust ports are being closed. The exhaust ports are closed before the inlet charge gets close to the exhaust ports due to distance and speed factor. The charge is mixed with exhaust left behind, then compressed to be ignited for the next cycle. Since no transfer ports are needed at about BDC, the exhaust ports can be smaller and nearer to BDC to allow for more room and higher compression ratio. More ports can now be located around the cylinder at BDC to distribute heat equally around the piston crown. More ports means shorter ports can be used to further increase the compression ratio. This works great for compression ignition like diesel. This design now incorporates a VVT powered simply by air pressure. As this engine speeds up, the less time the exhaust gets to leave the combustion chamber, causing exhaust pressure back in the cylinder. As long as this pressure is less than the inlet charge pressure, charges will continue to push the intake valve open to enter the combustion chamber. The faster the engine runs, the higher the pressure, the higher the compression ratio, hence variable compression ratio (VCR). The intake valve is equipped with means such as spring or a pair of magnets repulsing each other wherein one magnet piece is attached to the valve stem while the other piece of magnet is mounted in the valve stem support compartment to keep the intake valve floating or shut when not in use. The exhaust ports may be adjustable by means to be at times partially shut, allowing the operator to choose between more torque or horsepower wherein the closer the ports are open near to BDC, the more torque this engine will produce, and the wider the exhaust ports are open the more horsepower this engine may produce. A plurality of these two stroke engines may be adapted to share some common components including crankshaft, engine block, air intake and exhaust manifold.

This engine can be manufactured by stamping both sides of a hot metal to create a rough shape of the engine. Then, the edges, holes and surfaces that interact with other components can be machined or drilled. This engine is symmetrical; therefore, manufacturers can pour molten metals into a spinning mold to create the engine block. The engine block can also be encased into another metal jacket the same way.

This engine can work without onboard computers since most sensors required to meet air pollution requirements are not necessary. This engine can be connected to two different fuel sources. One of the fuel sources can be shut during normal operation. Both combustion chambers can work independently or together to achieve engine boost on demand. A 360 degree oil pickup component may be mounted axially to feed the oil pump and to allow the engine to run at any angle.

The preferred embodiment of this engine consists of two independent engines sharing the same axle and, cam and flywheels. Should any other components fail, there exists a redundant component to take over. Since there are two identical complete combustion chambers with their respective components, should any one of them fails, the other independent engine module or combustion chamber will take over. Should the oil pump or oil filters fail, the oil splashing on the engine block will seep through the engine block bearings for lubrication. Also, the hydraulic pump will suck in oil from the oil sump through a bypass route. Each combustion chamber has a pair of air inlets and valves, and at least a pair of exhaust ports allowing for redundancy flexibility. Power valves may be used with this engine. Each combustion chamber is equipped with a pair of spark plugs. Each spark plug and injector has its own supply harness. The bypass air inlet manifolds 68a and 68b come in pair. The air filters and oil filters come in pairs and work independently. The oil pressure release valves come in pairs where one is mounted on each side of the engine. Oil from the remote oil distributor component takes two routes 120pb to the engine block. Should a piston or combustion chamber fails, the other combustion chamber will take over.

A key aspect of this invention is the location and direction of the follower translating with the cam profile. The long moment arm and line of action helps to generate optimum torque and horsepower. By arranging the pistons in opposed way, the action of the ignition goes towards one cam while the reaction of the ignition goes towards the other cam. The forces on both cams are directed towards a central axle resulting in a recoilless operation. The synergy of features and configurations allow for a very much fuel efficient engine.

The followers self-adjust to the shape of the cam profile. The followers do not have to rotate since they can glide on the cam profile. Extrusion on the follower support component can be adapted to stop the followers from over rotating. The edges between the dwells and the cam curves cause the edges of the followers to be self-rounded to prevent sharp edges from scratching the cam. Particles caught within the follower and the cam profile are being flushed out by hydraulic fluid at the dwell locations. Fan blades may be drilled and shaped on the flywheels to vent the engine block. Cam profiles may be machined on the flywheels or cam support plates. Intake valves may be actuated by other means besides pressure differential. Oil channels may be drilled in piston component or assembly to transfer hydraulic fluid from one side of the engine block to the other.

This engine has an improved exhaust system with means for allowing uninterrupted flow of exhaust by allowing the back lower pressure, normally created by the exhaust pulse coming out of the combustion chamber, to draw in new air from a plurality of bypass channel to fill in the vacuum void at all times and in every cavity of the exhaust system at any speed. This is similar to piercing a hole at the bottom of a bottle to facilitate the emptying of the fluid within while holding the bottle upside down. This method normally allows us to empty the bottle faster with less noise. This noiseless exhaust system works similarly. This means higher horsepower since less power is used to push the exhaust out. The uninterrupted momentum of the expanding gas from the combustion chamber is gradually redirected to the exhaust pipes by the shape of the piston head and the angle of the exhaust ports. Another benefit of this embodiment is higher compression ratio In the case of exhaust reversion, where the exhaust tail pipe is obstructed, causing a higher than normal exhaust scavenging process of high back pressure exhaust and higher intake pressure from the pump and turbocharger, resulting in more power. Too much exhaust back pressure will result in exhaust gas flowing back to air intake, protecting the engine according to the present invention from runaway increase in compression ratio, the turbocharger, NOx production and the environment. In a typical engine, the exhaust pathways are normally restricted by a turbocharger. Therefore, some of the efficiency of a turbocharger is used towards pushing out the increase of back pressure exhaust gas during the exhaust stroke. A benefit of this embodiment is that the restriction and higher back pressure exhaust caused by the turbocharger is also used towards creating a higher compression ratio, in addition to the compressed intake by the turbocharger. In other words, adding a turbocharger to this engine will add more power than adding the same turbocharger to a current internal combustion engine. Contrary to current internal combustion engines, adding a turbocharger to this engine will increase intake manifold boost pressure without the bad side effects in current engines.

1. A method for achieving variable valve timing, in an internal combustion engine by simply using air pressure comprising:
At least one cylinder intake valve to be mounted at about Top Dead Center,
A one-way valve located between the said intake valve and a throttle body of a fuel metering unit to prevent trapped charged from exiting back to the throttle body,
Means for sucking and compressing intake charge against the intake valve,
Wherein the said intake valve is pushed open by the trapped compressed charge as soon as pressure level in the combustion chamber drops lower than the pressure of the trapped charge.

2. A method according to claim 1, wherein the means for compressing intake charge is the rear of the piston reciprocating within a sealed back chamber with air passages leading and joining the gap between the cylinder intake valve and the one-way valve.

3. According to claim 1, wherein at least one of the intake valves is equipped with a pair of magnets adapted to oppose one another wherein the magnet mounted in the valve support compartment is adapted to repulse the other magnet mounted on the valve stem to force the intake valve to remain about shut when the engine is not running.

4. According to claim 1, wherein at least one of the intake valves is equipped with a small spring to force the said valve to remain about shut when the engine is not running

5. A method according to claim 1, wherein variable fuel and air ratio (VFAR) is achieve by using air pressure,
Wherein a bypass air channel links the sealed back chamber with a source of fresh air to allow the trapped charge to be diluted more for lean burn,
Wherein a plurality of ports or valves are located about the piston skirt to be opened and closed by the movement of the piston near top dead center, to suck in fresh air from the bypass air channel due to partial vacuums caused by the throttle body
Wherein the wider the throttle valve is open the richer the trapped charge will be to produce more power, and to run lean the rest of the time in accordance with the throttle valve position.

6. A method according to claim 1, wherein variable compression ratio is achieved by engine speed without wasting fuel in the process,
Wherein the higher engine speed gets, the less time the exhaust has to completely leave the combustion chamber in a two stroke engine, leaving some pressurized exhaust back in the cylinder at about bottom dead center to be added to the engine normal intake charge compression volume,
Wherein the intake charge is pushed into the combustion chamber behind the exhaust exiting, producing the effect of filling the vacuum left behind the exhaust flow, and pushing exhaust out first should there be enough time during scavenging,
Wherein the higher the engine RPM gets, the more exhaust is left back in the combustion chamber before compression stroke starts, so the higher the compression ratio.

7. a method according to claim 1, wherein excessive speed detection and prevention is implemented with pressure difference,
Wherein the exhaust pressure at about bottom dead center will determine how much fuel/air mixture in the trapped chamber will be allowed to enter the combustion chamber to be ignited due to pressure difference in both chambers,
Wherein at idle, a leaner mixture with abundance of Oxygen will be found in the pre-compression chamber for combustion due to more vacuum caused by the throttle valve position, and the wider the throttle valve was open, the richer the mixture will be, producing more power during combustion cycle to be more responsive when needed and to run leaner the other times,
Wherein at a specific speed range, the pressure difference in both chambers will start to match, at which point less fuel will enter the combustion chamber, producing less power to slowdown and protect the engine while running at maximum torque and efficiency.

8. A method according to claim 1, wherein other obstruction to the exhaust flow caused by a governor controlled mechanism or a lever, may produce the same effect of maximum torque at high efficiency.

9. A method according to claim 1, wherein an indicator maybe associated with the engine RPM known to require upshift to alert the operator about when to upshift to achieve more horsepower and efficiency.

10. A method for achieving Shaped charged combustion chamber comprising: a substantially conical concave cylinder head projected towards the piston crown wherein the only larger space available for gas expansion is about the axis of the cylinder where gases can first speed up towards the center of the piston crown without obstruction creating a low pressure zone around the axis of the cylinder where expanding gases from about the cylinder walls will rush in to fill, resulting in shaping most expanding gases in the combustion chamber towards the piston head.

11. A method according to claim 10, wherein two cylinders share the same conical hole forming a venturi shape at the center of their cylinder heads, allowing for gas expansion from both cylinders to travel towards the axis of one another.

12. A method according to claim 10, wherein the gap between the cylinder wall and piston crown is progressively smaller from the center top of the piston head towards the cylinder wall as a means to guide the gas expansion to the piston crown since fluid travels the path of least resistance.

13. A method for a quieter exhaust system comprising:
a. At least one exhaust pathway
b. At least one air intake bypass pathway
Wherein at least one of each of these pathways are joined at the exhaust valves or ports in the cylinder wall, right where the exhaust gases leave the combustion chamber to allow air from the intake bypass pathway to fill in the low pressure zones as gases leave the combustion chamber, in a manner that creates no drag in the exhaust system that is enough to cause the gases to pulse and create frequencies that our ears and brain can interpret as noisy.

14. According to claim 13, wherein the air intake bypass pathway is the engine case which is attached directly or indirectly to the air filter housing or any other source of air.

15. According to claim 13, wherein the exhaust goes over the piston head near bottom dead center and through the exhaust ports forming a relatively venturi shape that allows the exhaust to go to the exhaust pipes while at the same time allowing the bypass air in the engine case to be sucked in the exhaust pipe like emptying a bottle with a hole at the bottom allowing the fluid to flow without pulsing.

16. An engine that produces no reaction torque comprising:
a. a stationary engine block having at least one offset cylinder from the center line of the engine axle
b. two opposed pistons moveable coaxially within the said offset cylinder, sharing the same combustion chamber
c. at least one cam follower is associated with each one of the said opposed pistons
d. a cam plate with gears rotatable about the axis of the engine, in one direction on one side of the said engine block, parallel to the axis of the said opposed pistons
e. another cam plate with gears, rotatable about the axis of the engine, in opposite direction on the other side of the said engine block and parallel to the axis of the said opposed pistons
f. an endless cam track within each said cam plate engaging the said at least one cam follower to allow each one of the said opposed pistons to independently reciprocate traveling towards bottom dead center then returning towards top dead center
g. at least one engine axle with gears to engage gears on said counter rotating cam plates
h. wherein the combustion event within the shared combustion chamber applies forces to both opposed pistons equally, then to the said cam plates via the cam followers, finally to the said engine axle,
i. wherein the reactive torque from each of the said opposed pistons is applied at equidistance, clockwise and counter-clockwise respectively on opposite end of the said engine block cancelling the reaction toque that was the opposite of the torque applied on the axle.

17. An engine according to claim 16, wherein the teeth of said gears on said engine axle is the sun gear of a planetary gear unit and engages with the pinions of the planetary gear unit,
wherein the teeth of the ring gear of the said planetary gear unit are in one of the said cam plates turning in one direction, engaging with the pinion gears, while the other said cam plate turns the pinions support component in the opposite direction.

18. An engine according to claim 16, wherein the said cam follower is mounted directly on either the elongated piston skirt, or on a separate piston arm, wherein both the piston skirt and the said separate piston arm are adapted to transfer their thrusts to the said engine block or on optional supporting bodies.

19. An engine according to claim 16, wherein the piston skirt or piston arm actuates a hydraulic pump to force hydraulic fluid in between piston arm bearings to lubricate cam follower components and to allow the corresponding components to hydroplane while moving against each other and to equally distribute piston arm thrusts in all directions.

20. An engine according to claim 16, wherein the said cam tracks are adapted to allow one set of the said opposed pistons to be at about Top Dead Center while the other set of the said opposed pistons to be at about Bottom Dead Center to produce a relatively straight line torque output.

21. An engine according to claim 16, wherein each combustion chamber forms a fully balanced reaction-free torque engine.

22. An engine according to claim 16, wherein the at least one of the said opposed pistons has another piston shaped cylinder working within it to seal and compress the charge or some part of the charge on its downstroke in a volume other than that of the engine case.

23. An engine according to claim 22, wherein the volume may have at least one port to be uncovered by the piston skirt to allow more air in to further dilute the charge already in the said volume or chamber.

24. An engine according to claim 16, wherein the said cam follower is relatively flat, collinearly shaped to the cam track, forming a relatively small bearing with oil passages at the center for allowing both parts to hydroplane against each other when moving.

25. An engine according to claim 16, wherein the profile of the said cam tracks is traced from the golden spiral geometry, or preferably curved to allow for constant moment arm length during downstroke to produce constant torque cycle.

26. A method for distributing side thrusts caused by pistons that generate reactive torque comprising:
a. two solid bearings
b. at least one one-way valve
c. wherein the said solid bearings form a cavity in between to allow hydraulic fluid to be sucked in and compressed
d. wherein each one of the said bearing has an extruded section adapted so when mated together formed a closed cylinder
e. wherein at least one cavity or port is located in the at least one of the said solid bearings to facilitate the at least one one-way valve to allow hydraulic fluid to travel one way in and another way out, and to be forced in between moving components to hydroplane
f. wherein the hydraulic fluid exerts forces in all directions to cancel side thrusts caused by reaction torque of the pistons
g. wherein excessive hydraulic pressure is released rapidly along the way so not to cause damage during normal operations and during failure.

27. A one-cylinder two stroke engine comprising:
a. a single piston housing
b. a piston located within the housing forming a combustion chamber
c. at least one cylinder intake valve located at about engine Top Dead Center (TDC)
d. at least one rear compression chamber linking said intake valve to a throttle body from and air fuel metering device like a carburetor
e. a one-way valve located between the rear compression chamber and the throttle body allowing fuel and air to enter the rear compression chamber to be compressed and injected into the combustion chamber
f. a crankshaft in a crankcase, adjacent to the piston housing and sealed therefrom forming the rear compression chamber,
g. a connecting rod, pivotal connection means between the crankshaft and the piston
h. wherein the rear compression chamber is the volume in the crankcase which is extended to reach the intake valves
i. wherein the bottom of the piston also serves as a pump, sucking and compressing air and fuel mixture into the rear compression chamber, then through the intake valves
j. wherein the said intake valves are actuated by air pressure difference between the compressed air/fuel mixture in the rear compression chamber and the exhaust pressure within the combustion chamber when the piston is at about Bottom Dead Center (BDC)
k. wherein during normal operation, the piston moves up, creating a low pressure zone in the rear compression chamber where the one-valve between the rear compression chamber and the throttle body is pushed open by the ambient air pressure, letting new fuel and air in to fill the rear compression chamber, and
l. wherein at the same time compresses fuel and air mixture within the combustion chamber and shuts the intake valve due to now higher pressure in the combustion chamber compared to fuel and air mixture from the rear compression chamber, and
m. wherein the fuel and air mixture is then ignited by either compression heat or a sparkplug, then the hot gas from the combustion event pushes the piston down and turns the crankshaft, while at the same time shuts the one-way valve, due to now higher pressure of the fuel and air mixture in the rear compression chamber being compressed, and
n. wherein the pressure of the fuel and air mixture in the rear compression chamber gets higher while the pressure in the combustion chamber gets lower towards BDC, until the intake valves are now pushed open by the pressure difference to inject new fuel and air mixture into the combustion chamber for the next cycle.

28. A two stroke engine according to claim 27, wherein the intake valve may be equipped with means such as spring or a pair of magnets repulsing each other wherein one magnet piece is attached to the valve stem while the other piece of magnet is mounted in the valve stem support compartment to keep the intake valve shut when not in use.

29. A two stroke engine according to claim 27, wherein a plurality of ports are located on the cylinder wall, connected to at least one bypass air passages from an air filter wherein the piston skirt uncovers the ports while the piston is at about TDC to allow more air in, due to a partial vacuum in the rear compression chamber caused by a partially opened throttle valve during low acceleration or at idle position, to further dilute the fuel and air mixture ratio in the rear compression chamber to achieve lean burn.

30. A two stroke engine according to claim 27, wherein exhaust ports are adjustable by means to be partially shut, allowing the operator to choose between more torque or horsepower, wherein the closer the ports are open near to BDC, the more torque this engine will produce, and the wider the exhaust ports are open the more horsepower this engine may produce.

31. A two stroke engine according to claim 27, wherein a plurality of these two stroke engines may be adapted to share some common components including crankshaft, engine block, air intake and exhaust manifold.

32. A modular single cylinder cam follower engine with less reaction torque and with rear compression chamber comprising:
a. a stationary engine block with one cylinder
b. a piston moveable coaxially within the said cylinder
c. at least one cam follower is associated with the said piston
d. a cam plate rotatable about the axis of the engine, parallel to the axis of the said piston
e. an endless cam track within each said cam plate engaging the said at least one cam follower to allow the said piston to reciprocate traveling towards bottom dead center then returning towards top dead center
f. an engine axle to engage and rotate with the said cam plate
g. wherein the combustion event within the combustion chamber pushes the said piston downwards, turning the said cam plate and engine axle
h. wherein the reaction torque of the said piston is applied on the engine block, clockwise and counter-clockwise respectively on opposite end of the said engine block to nearly cancel the reactive torque resulted from the torque applied on the axle
i. wherein the said piston has another cylinder working within to seal and compress the charge or some part of the charge on its downstroke in a volume other than that of the engine case.

33. A modular single cylinder engine according to claim 32, wherein the volume other than that of the engine case, may have at least one port to be uncovered by the piston skirt to allow more air in to further dilute the charge already in the said volume or chamber.

34. A modular single cylinder engine according to claim 32, wherein the profile of the said cam tracks is traced from the golden spiral geometry, or optionally curved to allow for constant moment arm length during downstroke.

35. A modular single cylinder engine according to claim 32, wherein the said cam follower is mounted directly on the elongated piston skirt, or on a separate piston arm wherein both the piston skirt and the said separate piston arm are adapted to transfer their thrusts to the said engine block or any other supporting body.

36. A modular single cylinder engine according to claim 32, wherein the said piston skirt or said piston arm actuates a hydraulic pump to force hydraulic fluid in between piston arm bearings to lubricate cam follower components and to allow the corresponding components to hydroplane while moving against each other and to equally distribute piston arm thrusts in all directions.

37. A modular single cylinder engine according to claim 32, wherein the said cam follower is relatively flat, collinearly shaped to the cam track, forming a relatively small bearing with oil passages at the center for allowing both parts to hydroplane when moving.

38. A remote oil distributor with redundancy and failover capability comprising:
a. a base plate with adapters to connect hoses to and from an internal combustion engine or oil cooler
b. at least one valve coupled with one spring
c. at least one hose
d. at least one oil filter
e. wherein the said oil filters are screwed in the said base plate which has the said valve within and forced in place by the said spring to allow oil from said hose to travel in one direction from an external oil pump then out to the hoses that are attached back to an engine block for lubrication
f. wherein another hose from an oil sump of an engine is connected to the said base plate to be blocked by the said valve which is being pushed by the oil pressure from the hose coming from the remote oil pump
g. wherein during normal operation, oil is pushed out to the said base plate by the remote oil pump, then this oil pressure pushes the said valve to shut the other hose coming from the oil sump, then pushes oil back to the engine connectors and oil gallery
h. wherein during low oil pressure or oil delivery failure, the said valve is forced open to allow another oil pump from the piston arm to suck oil directly from the oil sump to the engine block, so to bypass the remote oil filters and delivery pathways.
